(19) United States
(12) Patent Application Publication
(10) Pub. No.: US 2020/0333791 A1
(43) Pub. Date: Oct. 22, 2020

(54) DRIVING ASSISTANCE SYSTEM

(71) Applicants: Toyota Jidosha Kabushiki Kaisha, Toyota-shi Aichi-ken (JP); National University Corporation Tokyo University of Agriculture and Technology, Tokyo (JP); School Judicial Person Ikutoku Gakuen, Atsugi-shi (JP)

(72) Inventors: Shintaro Inoue, Naka-gun (JP); Pongsathorn Raksincharoensak, Tokyo (JP); Yuichi Saito, Tokyo (JP); Hideo Inoue, Ashigarakami-gun (JP)

(21) Appl. No.: 16/834,513

(22) Filed: Mar. 30, 2020

(30) Foreign Application Priority Data
Apr. 19, 2019 (JP) 2019-079944

(51) Int. Cl. G05D 1/02; G01C 21/34; B60W 50/14; B60W 60/00

(52) U.S. Cl. CPC G05D 1/0214; G01C 21/3492; B60W 2554/40; B60W 60/0051; B60W 2050/146; B60W 50/14

(57) ABSTRACT

A driving assistance system is configured to include: a map database; a vehicle position recognition unit; an external environment recognition unit; a road environment recognition unit; an explicit risk determination unit; a vehicle behavior risk margin calculation unit configured to calculate a vehicle behavior risk margin when it is determined that an explicit risk is present; a road environment risk margin calculation unit configured to calculate a road environment risk margin from the road environment using data in which a risk evaluation value relating to a latent risk accompanying the explicit risk and the road environment are associated with each other in advance, if the explicit risk determination unit determines that the explicit risk is present; and a driving assistance switching unit configured to perform switching whether to perform the driving assistance relating to the latent risk based on the road environment risk margin and the vehicle behavior risk margin.

### CROSS-REFERENCE TO RELATED APPLICATIONS

This application claims the benefit of priority from Japanese Patent Application No. 2019-079944, filed on Apr. 19, 2019, the entire contents of which are incorporated herein by reference.

### TECHNICAL FIELD

The present disclosure relates to a driving assistance system.

### BACKGROUND

In the related art, a technology for providing a driving assistance relating to a latent risk while taking a latent risk present in a blind spot of an obstacle in front of a vehicle into consideration (refer to Japanese Unexamined Patent Publication No. 2017-206117).

### SUMMARY

The possibility of a presence of a latent risk accompanying an explicit risk such as obstacles is considered to vary depending on a road environment. Therefore, for example, if the driving assistance relating to the latent risk is performed under the assumption that the latent risk is always present, the driver of the vehicle may feel discomfort.

In this technical field, it is desired to provide the driving assistance relating to the latent risk while suppressing the driver from feeling the discomfort and taking the possibility of the presence of the latent risk accompanying the explicit risk into consideration.

A driving assistance system according to an aspect of the present disclosure is a system that can perform a driving assistance for a vehicle, the system includes: a vehicle speed recognition unit configured to recognize a vehicle speed of the vehicle; a map database configured to store map information; a vehicle position recognition unit configured to recognize a position of the vehicle on a map; an external environment recognition unit configured to recognize an external environment of the vehicle; a road environment recognition unit configured to recognize a road environment in front of the vehicle based on the position of the vehicle on the map, the map information, and the external environment; an explicit risk determination unit configured to determine whether or not an explicit risk is present in front of the vehicle based on the external environment; a vehicle behavior risk margin calculation unit configured to calculate a vehicle behavior risk margin based on a result of recognition performed by the vehicle speed recognition unit, if it is determined by the explicit risk determination unit that the explicit risk is present; a road environment risk margin calculation unit configured to calculate a road environment risk margin from the road environment using data in which a risk evaluation value relating to a latent risk accompanying the explicit risk and the road environment are associated with each other in advance, if it is determined by the explicit risk determination unit that the explicit risk is present; and a driving assistance switching unit configured to perform switching whether or not to perform the driving assistance relating to the latent risk based on the road environment risk margin and the vehicle behavior risk margin.

In the driving assistance system according to an aspect of the present disclosure, the driving assistance switching unit performs switching whether or not to perform the driving assistance relating to the latent risk based on the road environment risk margin as well as the vehicle behavior risk margin which is based on the result of recognition performed by the vehicle speed recognition unit. Here, the road environment risk margin is calculated from the road environment, for example, as the total value of the risk evaluation values using data in which the risk evaluation value of the latent risk accompanying the explicit risk and the road environment are associated with others in advance. Therefore, according to the driving assistance system in an aspect of the present disclosure, it is possible to perform switching whether or not perform the driving assistance relating to the latent risk while taking a fact that the possibility of presence of the latent risk accompanying the explicit risk varies depending on the road environment into consideration. As a result thereof, for example, it is possible to perform the driving assistance relating to the latent risk while suppressing the driver from feeling the discomfort and taking the possibility of presence of the latent risk accompanying the explicit risk into consideration compared to a case where the driving assistance relating to the latent risk is performed on the vehicle under the assumption that the latent risk is always present.

In an embodiment, the driving assistance switching unit may be configured to perform switching such that the driving assistance relating to the latent risk is not performed if the road environment risk margin is equal to or greater than a first threshold value and the vehicle behavior risk margin is equal to or greater than a second threshold value, and the driving assistance switching unit may be configured to perform switching such that the driving assistance relating to the latent risk is performed, if the road environment risk margin is less than the first threshold value or the vehicle behavior risk margin is less than the second threshold value. In this way, if the road environment risk margin is equal to or greater than the first threshold value and the vehicle behavior risk margin is equal to or greater than the second threshold value, since the driving assistance relating to the latent risk is not performed, it is possible to suppress the driver from feeling the discomfort.

In an embodiment, the driving assistance system may be configured to include an intervention performing unit configured to perform a vehicle control intervention for an avoidance of the latent risk as the driving assistance relating to the latent risk based on a result of switching performed by the driving assistance switching unit. The driving assistance switching unit may be configured to perform switching such that the vehicle control intervention is performed, if the road environment risk margin is less than the first threshold value and the vehicle behavior risk margin is less than the second threshold value. In this case, it is possible to suppress the driver from feeling the discomfort compared to a case where the vehicle control intervention is performed under the assumption that the latent risk is always present.

In an embodiment, the intervention performing unit may be configured to decelerate the vehicle such that the vehicle speed does not exceed an upper limit vehicle speed of the vehicle set according to the road environment risk margin, if a deceleration intervention is performed as the vehicle control intervention to the vehicle. In this case, it is possible to perform the deceleration intervention using the upper limit vehicle speed in which the possibility of presence of the latent risk accompanying to explicit risk is taken into consideration.

In an embodiment, the driving assistance system may be configured to further includes a driver notification performing unit configured to perform a driver notification that is a notification of information relating to the latent risk to the driver of the vehicle as the driving assistance relating to the latent risk, based on the result of switching performed by the driving assistance switching unit. The driving assistance switching unit may be configured to perform switching such that the driver notification is performed, if the road environment risk margin is less than the first threshold value and the vehicle behavior risk margin is equal to or greater than the second threshold value, or if the road environment risk margin is equal to or greater than the first threshold value and the vehicle behavior risk margin is less than the second threshold value. In this case, it is possible to alert the driver while suppressing the driver from feeling the discomfort compared to a case where the driver notification is performed under the assumption that the latent risk is always present.

In an embodiment, the driving assistance system may be configured to further includes a display unit configured to display the information to the driver of the vehicle. The driver notification performing unit may be configured to display an integrated risk margin that varies according to the road environment risk margin and the vehicle behavior risk margin on the display unit. In this case, it is possible for the driver to recognize the degree of attention to be paid to the latent risk accompanying the explicit risk via the integrated risk margin that varies depending on the road environment risk margin and the vehicle behavior risk margin.

In an embodiment, the driving assistance system may be configured to further include a display unit configured to display the information for the driver of the vehicle. The driver notification performing unit may be configured to acquire a road environment recognized by the road environment recognition unit, acquire an attention alert image corresponding to the acquired road environment, based on attention alert image information stored in advance in association with the road environment, if the vehicle behavior risk margin is less than the image display threshold value, determine a blinking mode such that the attention alert image blinks at a shorter cycle compared to a case where the vehicle behavior risk margin is equal to or greater than the image display threshold value, and display the attention alert image on the display unit in the determined blinking mode. In this case, it is possible to alert the driver according to the vehicle behavior risk margin in response to the changes of the blinking cycle of the attention alert image.

According to the present disclosure, it is possible to provide the driving assistance relating to the latent risk with taking the possibility of the presence of the latent risk accompanying the explicit risk into consideration while suppressing the driver from feeling the discomfort.

### BRIEF DESCRIPTION OF THE DRAWINGS

FIG. 1 is a block diagram illustrating a driving assistance system in an embodiment.

FIG. 2 is a plan view for explaining an example of a latent risk.

FIG. 3 is a plan view for explaining another example of a latent risk.

FIG. 4 is a table illustrating an example of a road environment, conditions, and risk evaluation values.

FIG. 5 is a diagram illustrating an example of switching the driving assistance relating to the latent risk.

FIG. 6 is a plan view schematically illustrating an example of performing a deceleration intervention.

FIG. 7 is a plan view schematically illustrating an example of performing a steering intervention.

FIG. 8 is a diagram illustrating an example of displaying an integrated risk margin on a display unit.

FIG. 9A is a diagram illustrating an example of changes of the image display modes.

FIG. 9B is a diagram illustrating an example of displaying an image on the display unit.

FIG. 10 is a flowchart exemplifying an outline of driving assistance switching processing.

FIG. 11 is a flowchart exemplifying details of the driving assistance switching processing.

FIG. 12 is a flowchart exemplifying deceleration intervention processing.

FIG. 13 is a flowchart exemplifying steering intervention processing.

FIG. 14 is a flowchart illustrating an example of driver notification processing.

FIG. 15 is a flowchart illustrating another example of driver notification processing.

### DETAILED DESCRIPTION

Hereinafter, an exemplary embodiment will be described with reference to the drawings.

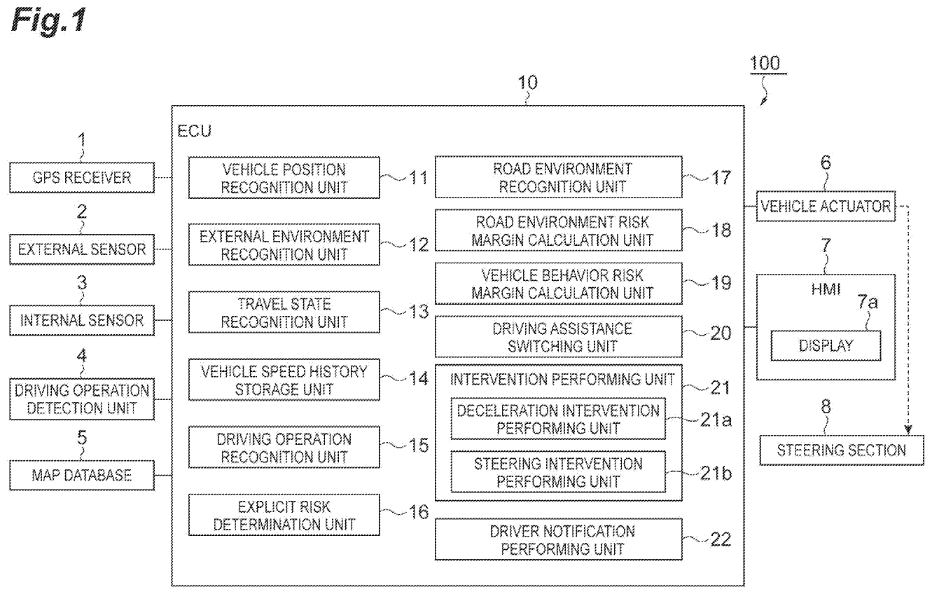

FIG. 1 is a block diagram illustrating a driving assistance system in an embodiment. A driving assistance system 100 illustrated in FIG. 1 is a system that performs a driving assistance to assist a driver of a vehicle such as passenger cars.

The driving assistance system 100 is configured to be capable of performing the driving assistance for the vehicle. If the driver allows the driving assistance, the driving assistance system 100 switches whether or not to perform the driving assistance relating to a latent risk based on road environments where the vehicle travels or the like, and changes the content of the driving assistance when performing the driving assistance relating to the latent risk. In the driving assistance relating to the latent risk, as an example, a vehicle control intervention relating to avoiding a risk present in front of the vehicle and a driver notification that is a notification of information relating to a risk to the driver of the vehicle. The vehicle control intervention includes, for example, a deceleration assistance and a steering assistance.

In the present disclosure, the risk includes not only an explicit risk but also the latent risk. The explicit risk is a risk caused by an object that can be detected by external sensors in the vehicle. The latent risk is a risk that cannot be detected by the external sensors in the vehicle.

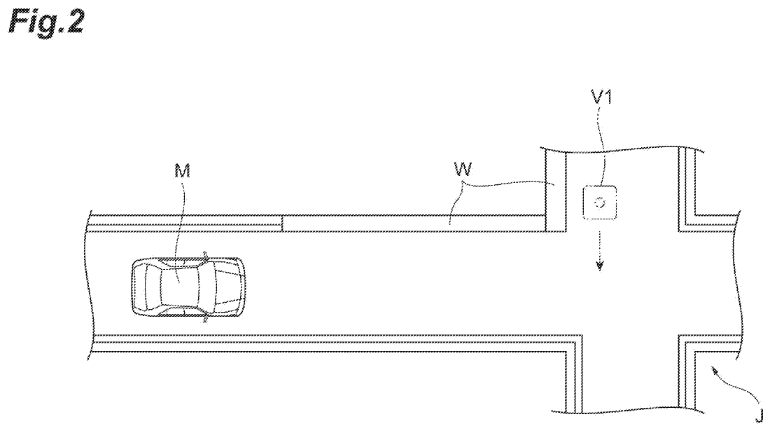

Here, FIG. 2 is a plan view for explaining an example of the latent risk. FIG. 2 illustrates a situation in which a vehicle M enters an intersection J where the line of sight is poor. In FIG. 2, the vehicle M, a wall W extending in an L shape in a plan view along the intersection J on the left side of vehicle M, and a virtual pedestrian V1 are illustrated. As illustrated in FIG. 2, as seen from the vehicle M, there is possibility that the virtual pedestrian V1 is likely to be present beyond the wall W. However, when the vehicle M approaches the intersection J where the line of sight is poor, the wall W becomes an obstacle, and thus, the external sensor 2 in the vehicle M cannot detect the virtual pedestrian V1 on the other side of the wall W. Therefore, in the example in FIG. 2, the virtual pedestrian V1 corresponds to the latent risk accompanying the wall W, the wall W corresponding to the explicit risk.

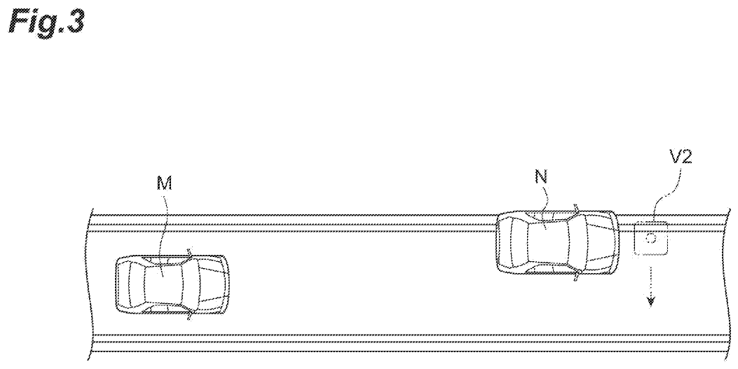

FIG. 3 is a plan view for explaining another example of a latent risk. In FIG. 3, the vehicle M, a road parked vehicle N in front of vehicle M, and a virtual pedestrian V2 are illustrated. As illustrated in FIG. 3, as viewed from the vehicle M, there is a possibility that the virtual pedestrian V2 is likely to be present beyond the road parked vehicle N. However, when the vehicle M approaches the road parked vehicle N, the road parked vehicle N becomes an obstacle, and thus, the external sensor 2 in the vehicle M cannot detect the virtual pedestrian V2 on the other side of the road parked vehicle N. Therefore, in the example in FIG. 3, the road parked vehicle N corresponds to the explicit risk, and the virtual pedestrian V2 corresponds to the latent risk accompanying the road parked vehicle N, the road parked vehicle N corresponding to the explicit risk.

### Configuration of Driving Assistance System

As illustrated in FIG. 1, the driving assistance system 100 includes an electronic control unit (ECU) 10 that performs an overall management of the system. The ECU 10 is an electronic control unit including a central processing unit (CPU), read only memory (ROM), random access memory (RAM), a control area network (CAN), a communication circuit and the like. In the ECU 10, for example, various functions are realized by loading a program stored in the ROM into the RAM and executing the program loaded in the RAM by the CPU. The ECU 10 may be configured with a plurality of electronic units.

The ECU 10 is connected to a GPS receiver 1, an external sensor 2, an internal sensor 3, a driving operation detection unit 4, a map database 5, a vehicle actuator 6, and a human machine interface (a display unit)(HMI)7.

The GPS receiver 1 measures a position of the vehicle (for example, latitude and longitude of the vehicle) by receiving signals from equal to or more than three GPS satellites. The GPS receiver 1 transmits information on the measured position of the vehicle to the ECU 10.

The external sensor 2 is a detection device that detects a surrounding situation of the vehicle. The external sensor 2 includes at least a camera. The external sensor 2 may include a radar sensor.

The camera is an imaging device that images an external situation of the vehicle. The camera is provided on the inside of a windshield of the vehicle and images the front of the vehicle. The camera transmits image information relating to the external situation of the vehicle to the ECU 10. The camera may be a monocular camera or may be a stereo camera.

The radar sensor is a detection device that detects obstacles around the vehicle using radio waves (for example, millimeter waves) or light. The radar sensor includes, for example, millimeter wave radar or a light detection and ranging (LiDAR). The radar sensor transmits the radio wave or light to the surroundings of the vehicle, and detects the obstacles by receiving the radio waves or the light reflected from the obstacles. The radar sensor transmits the detected obstacle information to the ECU 10. The obstacles include fixed obstacles such as guardrails and buildings, and moving obstacles such as pedestrians, bicycles, other vehicles, and the like. Other vehicles may include parked vehicles.

The internal sensor 3 is a detection device that detects a travel state of the vehicle. The internal sensor 3 includes a vehicle speed sensor, an accelerator sensor, and a yaw rate sensor. The vehicle speed sensor is a measurement device that measures a speed of the vehicle. As a vehicle speed sensor, for example, a vehicle wheel speed sensor is used, which is provided on vehicle wheels of the vehicle or on a drive shaft rotating integrally with vehicle wheels, and measures a rotational speed of the vehicle wheels. The vehicle speed sensor transmits the measured vehicle speed information (vehicle wheel speed information) to the ECU 10.

The accelerator sensor is a measurement device that measures an acceleration of the vehicle. The accelerator sensor includes, for example, a longitudinal accelerator sensor that measures acceleration in the longitudinal direction of the vehicle and a lateral accelerator sensor that measures a lateral acceleration of the vehicle. The accelerator sensor transmits, for example, acceleration information of the vehicle to the ECU 10. The yaw rate sensor is a measurement device that measures a yaw rate (rotation angular velocity) around the vertical axis at the center of gravity of the vehicle. As the yaw rate sensor, for example, a Gyro sensor can be used. The yaw rate sensor transmits the measured yaw rate information of the vehicle to the ECU 10.

The driving operation detection unit 4 detects an operation of the operation section of the vehicle by the driver. The driving operation detection unit 4 includes, for example, a steering sensor and a brake sensor. The operation section of the vehicle is a device to which the driver inputs an operation for driving the vehicle. The operation section of the vehicle includes at least one of a steering section 8 of the vehicle and a brake operation section of the vehicle. The steering section 8 is, for example, a steering wheel. The steering section is not limited to a case of wheel-shape but may be any configuration as long as it functions as a steering wheel. The brake operation section is, for example, a brake pedal. The brake operation section does not necessarily need to be a pedal, and any configuration may be used as long as the driver can input the deceleration operation.

The steering sensor measures an operation amount of the steering section 8 by the driver. The operation amount of the steering section 8 includes a steering angle. The operation amount of the steering section 8 may include a steering torque. The brake sensor measures an operation amount of the brake operation section by the driver. The operation amount of the brake operation section includes, for example, a depression amount of the brake pedal. The operation amount of the brake operation section may include a depression speed. The driving operation detection unit 4 transmits the operation amount information relating to the measured operation amount by the driver to the ECU 10.

The map database 5 is a database storing map information. The map database 5 is formed, for example, in a hard disk drive (HDD) mounted on the vehicle. The map information includes information on the position of the road, information on the shape of the road (for example, types of curves or straight roads, a curvature of the curve, or the like), information on the position of the intersection and the branch, and information on the position of a building. The map database 5 may be formed in a server that can communicate with the vehicle.

The map information includes information relating to road components. The road components mean structures or the like that constitute the road. The road components include a plurality of types. The road components include, for example, an area, a roadway, a sidewalk, an intersection, the number of lanes, and a presence or absence of a cross walk. The area means a region where the vehicle is traveling. The information relating to the road components is stored in the map database 5 in association with the positions on the map where the respective road components are present.

The vehicle actuator 6 is a device used for controlling the vehicle. The vehicle actuator 6 includes at least a drive actuator, a brake actuator and a steering actuator. The drive actuator controls a driving force of the vehicle by controlling an amount of air (throttle opening degree) supplied to the engine according to a control signal from the ECU 10. If the vehicle is a hybrid vehicle, in addition to the amount of air supplied to the engine, the control signal from the ECU 10 is input to a motor as a power source, and then, the driving force is controlled. If the vehicle is an electric vehicle, the control signal from the ECU 10 is input to a motor as a power source, and then, the driving force is controlled. The motor as the power source in these cases configures the vehicle actuator 6.

The brake actuator controls the brake system according to a control signal from the ECU 10 and controls a braking force applied to the wheels of the vehicle. For example, a hydraulic brake system can be used as the brake system. The steering actuator controls the driving of an assist motor controlling a steering torque of an electric power steering system according to a control signal from the ECU 10. In this way, the steering actuator controls the steering torque of the vehicle.

The HMI 7 is an interface that performs inputting and outputting of the information between the driving assistance system 100 and the driver. The HMI 7 includes, for example, a display 7a functioning as a display unit for displaying the information to the driver of the vehicle, a speaker, and the like. The HMI 7 outputs an image to the display 7a and outputs a voice from the speaker according to the control signal from the ECU 10. The display 7a is a display device that is mounted on a vehicle and displays an image in a display area. The image is an image displayed in the display area. The display 7a is controlled by the ECU 10 and displays the image in the display area.

The display 7a may be a head up display (HUD). The HUD is a display device for superimposing visual information onto the visual field of the driver of the vehicle. The HUD has a projection section installed in an instrument panel of the vehicle. The projection section projects an image on a display surface (a reflection surface inside the front windshield) of the front windshield via an opening section provided in the instrument panel. The driver can visually recognize the image based on the reflection on the display surface. The display area of the HUD is an area set on the front windshield in advance and is a range where the image is projected.

A multi-information display (MID) provided in the instrument panel or a liquid crystal display of the navigation system may be used as the display 7a.

Next, a functional configuration of the ECU 10 will be described. The ECU 10 includes a vehicle position recognition unit 11, an external environment recognition unit 12, a travel state recognition unit (a vehicle speed recognition unit) 13, a vehicle speed history storage unit 14, a driving operation recognition unit 15, an explicit risk determination unit 16, a road environment recognition unit 17, a road environment risk margin calculation unit 18, a vehicle behavior risk margin calculation unit 19, a driving assistance switching unit 20, an intervention performing unit 21, and a driver notification performing unit 22.

The vehicle position recognition unit 11 recognizes a position of the vehicle on the map based on information on the position from the GPS receiver 1 and the map information in the map database 5. In addition, the vehicle position recognition unit 11 may recognize the position of the vehicle using the simultaneous localization and mapping (SLAM), based on information on the position of a fixed obstacle such as a utility pole included in the map information in the map database 5 and a result of detection performed by the external sensor 2. The vehicle position recognition unit 11 may recognize the position of the vehicle on the map using a known method.

The external environment recognition unit 12 recognizes the external environment of the vehicle based on the result of detection performed by the external sensor 2 (at least one of the image captured by the camera and the object information from the radar sensor) and the position of the vehicle on the map recognized by the vehicle position recognition unit 11 and the map information. The external environment includes road situations around the vehicle and the object situations around the vehicle.

The road situations and the object situations includes information relating to the external environmental elements. The external environmental element means an external environment that can affect the traveling of the vehicle. The external environmental element includes a plurality of types. The external environmental element includes, for example, a road parked vehicle, a pedestrian, a traffic volume, a preceding vehicle, a time (current time period), weather, and an age of the pedestrian. The external environment recognition unit 12 recognizes the external environmental elements as the external environment based on the result of detection performed by the external sensor 2.

The external environment recognition unit 12 may recognize information in advance on whether or not the area is likely to be congested based on, for example, the map information as a traffic volume. The external environment recognition unit 12 may recognize the traffic volume, the time, the weather, and the like by the communication with the information center, for example.

The travel state recognition unit 13 recognizes the travel state of the vehicle based on the result of detection performed by the internal sensor 3. The travel state includes the vehicle speed of the vehicle, the acceleration of the vehicle, and the yaw rate of the vehicle. Specifically, the travel state recognition unit 13 recognizes the vehicle speed of the vehicle based on the vehicle speed information from the vehicle speed sensor. The travel state recognition unit 13 recognizes the acceleration of the vehicle based on the vehicle speed information from the accelerator sensor. The travel state recognition unit 13 recognizes the orientation of the vehicle based on the yaw rate information from the yaw rate sensor. The travel state recognition unit 13 functions as a vehicle speed recognition unit that recognizes the vehicle speed of the vehicle.

In addition, the travel state recognition unit 13 recognizes an actual steering angle of the vehicle as the travel state of the vehicle. The travel state recognition unit 13 can recognize the actual steering angle of the vehicle based on the result of detection performed by the steering sensor that configures the driving operation detection unit 4.

The vehicle speed history storage unit 14 is a database that stores a vehicle speed history of the vehicle. The vehicle speed history storage unit 14 may be configured in the RAM of the ECU 10, for example. The vehicle speed history storage unit 14 may be configured in the HDD mounted on the vehicle. The vehicle speed history storage unit 14 stores the vehicle speed history during the traveling of the vehicle based on, for example, the result of recognition of the vehicle speed performed by the travel state recognition unit 13. The vehicle speed history storage unit 14 stores the vehicle speed history for at least a fixed time retroactively from the current time. The fixed time may be 5 to 15 seconds, for example, and may be 8 seconds as an example. The vehicle speed history storage unit 14 does not need to be mounted on the vehicle, and may be formed on a server that can communicate with the vehicle.

The driving operation recognition unit 15 recognizes the driver's driving operation detected by the driving operation detection unit 4. The driving operation includes an operation of the brake operation section by the driver, and an operation of the steering section 8 by the driver. The driving operation recognition unit 15 may recognize the depression amount of the brake pedal by the driver based on the result of detection by the brake sensor. The driving operation recognition unit 15 may recognize the actual steering amount that is the operation amount of the steering section 8 by the driver, based on the result of detection by the steering sensor.

The explicit risk determination unit 16 determines whether or not the explicit risk is present in front of the vehicle based on the external environment of the vehicle recognized by the external environment recognition unit 12. Objects that are subject to the explicit risk can include other traveling vehicles, stopped vehicles, parked vehicles, falling objects, structures, bicycles, pedestrians, and the like. Other vehicles include not only four-wheel vehicles but also two-wheel vehicles and personal mobilities. The structures include construction equipment, road signs, utility poles, walls, fences, buildings, and the like.

The explicit risk determination unit 16 recognizes the explicit risk by the image processing such as a pattern matching based on, for example, the result of detection (the image captured by the camera) performed by the external sensor 2. The explicit risk determination unit 16 may recognize a plurality of explicit risks by the image processing. The explicit risk determination unit 16 may recognize the structure as an explicit risk based on the position of the vehicle on the map recognized by the vehicle position recognition unit 11 and the map information. In this case, the information on the position of the structure as the explicit risk may be stored in the map database 5 in advance. If at least one explicit risk is recognized in the captured image, the explicit risk determination unit 16 determines that the explicit risk is present in front of the vehicle.

When the explicit risk determination unit 16 determines that the explicit risk is present in front of the vehicle, the explicit risk determination unit 16 calculates an expected arrival time at the explicit risk. The expected arrival time can be calculated under an assumption of a situation (target situation) in which the vehicle approaches the explicit risk, by dividing a remaining distance to that situation by the vehicle speed of the vehicle. The remaining distance is a relative distance from the vehicle to the explicit risk. The remaining distance may be acquired based on the result of detection performed by the external sensor 2 or may be acquired based on the position of the vehicle on the map and the position of the explicit risk on the map.

For example, if it is determined that the explicit risk is present in front of the vehicle and when the calculated expected arrival time is equal to or shorter than a predetermined determination time Tᵣᵢₛₖ, the explicit risk determination unit 16 permits performing the processing by the road environment recognition unit 17, the road environment risk margin calculation unit 18, and the vehicle behavior risk margin calculation unit 19 described later. For example, the determination time Tᵣᵢₛₖ can be set to 2 to 5 seconds. In the description below, “if it is determined that the explicit risk is present in front of the vehicle and the calculated expected arrival time is equal to or shorter than the predetermined determination time Tᵣᵢₛₖ” is simply referred to as a “risk calculation timing”. The risk calculation timing means a timing at which processing for calculating each risk margin for performing the switching processing for the driving assistance relating to the latent risk, is started.

The road environment recognition unit 17 recognizes the road environment in front of the vehicle based on the position of the vehicle on the map, the map information, and the external environment. The road environment includes the road components included in the map information and the external environmental elements included in the external environment of the vehicle (the road situations and the object situations).

The road environment recognition unit 17 recognizes one or a plurality of road components included in the captured image at the risk calculation timing based on, for example, the position of the vehicle on the map and map information. The road environment recognition unit 17 recognizes the road components that are present in front of the position of the vehicle on the map at the risk calculation timing, for example. The road environment recognition unit 17 may recognize the road components in consideration of a detectable range of the external sensor 2 as a range on the map. The road environment recognition unit 17 may recognize the road components by the image processing such as the pattern matching of the result of detection (the image captured by the camera) performed by the external sensor 2.

The road environment recognition unit 17 recognizes external environmental elements based on the external environment recognized by the external environment recognition unit 12. The road environment recognition unit 17 recognizes the external environmental elements by, for example, the image processing such as the pattern matching of the result of detection (the image captured by the camera) performed by the external sensor 2.

If it is determined by the explicit risk determination unit 16 that the explicit risk is present, the road environment risk margin calculation unit 18 calculates the road environment risk margin from the road environment using data in which the risk evaluation value relating to the latent risk and the road environment are associated with each other in advance. For example, the risk evaluation value can be an index indicating the possibility of the presence of the latent risk accompanying the explicit risk. The road environment risk margin is an index that indicates the margin (a degree of allowance) for the risk that is affected by the road environment. For example, if it is determined by the explicit risk determination unit 16 that the explicit risk is present and when the calculated expected arrival time is equal to or shorter than the predetermined determination time Tᵣᵢₛₖ (at the risk calculation timing), the road environment risk margin calculation unit 18 calculates the risk evaluation value according to the road environment condition set for each road environment.

The road environment condition means a condition for the road environment that affects the possibility of the presence of the latent risk accompanying the explicit risk. The road environment condition includes a plurality of road component conditions classified into a plurality of conditions for one road component, and a plurality of external environmental element conditions classified into a plurality of conditions for one external environmental element. The road component condition means characteristics of the road components for classifying the types of the road components according to the possibility of presence of the latent risk. The road component conditions correspond to static driving environmental context. The external environmental element condition means characteristics of the external environmental elements for classifying the types of the external environmental elements according to the possibility of presence of the latent risk. The external environmental element conditions correspond to dynamic driving environmental context.

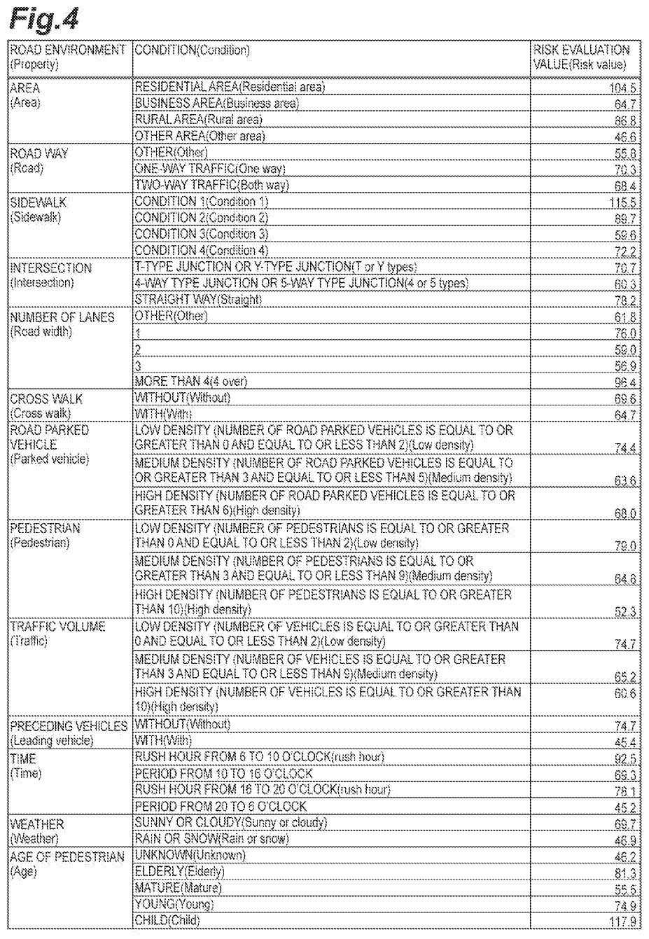

FIG. 4 is a table illustrating an example of the road environment, the conditions, and the risk evaluation values. FIG. 4 illustrates an example of data in which the road environment, the road environment condition, and the risk evaluation value are associated with each other in advance.

The road component conditions are illustrated in the upper half of the table in FIG. 4. Specifically, with regard to the areas, the road component conditions include, for example, a residential area, a business area, a rural area, and other area. With regard to the road ways, the road component conditions include, for example, a one-way traffic, a two-way traffic, and others. With regard to the sidewalks, the road component conditions include, for example, “there is no sidewalk (“Condition 1” in FIG. 4)”, “there is a sidewalk that is separated from the road way by a boundary line (“Condition 2” in FIG. 4)”, “there is a sidewalk that is separated from the road way by a curb (“Condition 3” in FIG. 4)”, and “there is a sidewalk that is separated from the roadway by a hedge (“Condition 4” in FIG. 4)”. Here, the “hedge” means, for example, plant trees that are higher than the curb, and shield the road way and the sidewalk to a position higher than the curb. With regard to the intersection, the road component conditions include, for example, a “a T-type junction or a Y-type junction”, “a 4-way type junction or a 5-way type junction”, and a “straight way”. The “straight way” means an intersection having a road that intersects at least one of the right side and the left side, and through which the vehicle passes straightly. The “straight way” may include, for example, a straight road with poor visibility and having a possibility that pedestrians may jump out from houses or parking lots alongside the straight road. With regard to the number of lanes, the road component conditions include, for example, 1 lane, 2 lanes, 3 lanes, 4 lanes or more, and others. With regard to the cross walk, the road component conditions include, for example, “with a cross walk” and “without a cross walk”.

The external environmental element conditions are illustrated in the lower half of the table in FIG. 4. Specifically, with regard to the road parked vehicle, the external environmental element conditions include, for example, a low density in which the number of road parked vehicles is equal to or greater than 0 and equal to or less than 2, a medium density in which the number of road parked vehicles is equal to or greater than 3 and equal to or less than 5, and a high density in which the number of road parked vehicles is equal to or greater than 6. With regard to the pedestrians, the external environmental element conditions include, for example, a low density in which the number of pedestrians is equal to or greater than 0 and equal to or less than 2, a medium density in which the number of pedestrians is equal to or greater than 3 and equal to or less than 9, and a high density in which the number of pedestrians is equal to or greater than 10. With regard to the traffic volume, the external environmental element conditions include, for example, a low density in which the number of vehicles is equal to or greater than 0 and equal to or less than 2, a medium density in which the number of vehicles is equal to or greater than 3 and equal to or less than 9, and a high density in which the number of vehicles is equal to or greater than 10. The density here may be the number of vehicles or pedestrians included in the captured image at the risk calculation timing. With regard to the preceding vehicle, the external environmental conditions include, for example, “with vehicles” and “without vehicles”. With regard to the time, the external environmental element conditions include, for example, a rush hour from 6 to 10 o'clock, a period from 10 to 16 o'clock, a rush hour from 16 to 20 o'clock, and a period from 20 to 6 o'clock. With regard to the weather, the external environmental element conditions include, for example, sunny or cloudy, and rain or snow. With regard to an age of the pedestrian, the external environmental element conditions include, for example, an unknown, an elderly, a mature, a young, and a child.

The risk evaluation value can be identified in advance by re-arranging the value with the road environment and the road environment conditions using a statistical method such as a logistic multiple regression based on, for example, statistical data (so-called Near-Miss Incident Database) in which a frequency of occurrences of accidents and close calls (so-called near miss cases) that were observed in the past as the recording results of the drive recorder and the like, are summarized.

Here, the risk evaluation values have a magnitude relationship according to a plurality of road component conditions (or the external environmental element conditions) for one road component (or for one external environmental element). For example, if the road component is the “cross walk”, the risk evaluation value when the road component condition is “without the cross walk” is larger than the risk evaluation value when the road component condition is “with the cross walk”.

However, there may be a case having a specific tendency depending on a plurality of road component conditions for one road component. For example, if the road component is the “sidewalk”, the risk evaluation value when the road component condition is “there is no sidewalk” is larger than the risk evaluation value when the road component condition is “there is a sidewalk that is separated from the road way by a boundary line”. The risk evaluation value when the road component condition is “there is a sidewalk that is separated from the road way by a boundary line” is larger than the risk evaluation value when the road component condition is “there is a sidewalk that is separated from the road way by a curb”. However, the risk evaluation value when the road component condition is “there is a sidewalk that is separated from the road way by a curb” is smaller than the risk evaluation value when the road component condition is “there is a sidewalk that is separated from the road way by a hedge”. In other words, the case of “hedge” that clearly separates the sidewalk and the road way from each other may have a higher possibility of the presence of the latent risk.

There may be a case where the risk evaluation value has a specific tendency depending on a plurality of external environmental element conditions for one external environmental element. For example, if the external environmental element is the “road parked vehicle”, the risk evaluation value when the external environmental element condition is “a low density in which the number of road parked vehicles is equal to or greater than 0 and equal to or less than 2” is larger than the risk evaluation value when the external environmental element condition is “a medium density in which the number of road parked vehicles is equal to or greater than 3 and equal to or less than 5”. The risk evaluation value when the external environmental element condition is “a high density in which the number of road parked vehicles is equal to or greater than 6” is larger than the risk evaluation value when the external environmental element condition is “a medium density in which the number of road parked vehicles is equal to or greater than 3 and equal to or less than 5”. In other words, the case of “medium density” in which the density of the road parked vehicle is relatively sparse may have a lower possibility of presence of the latent risk than the cases of the “low density” or the “high density”.

For example, if it is determined by the explicit risk determination unit 16 that the explicit risk is present and when the calculated expected arrival time is equal to or shorter than the predetermined determination time Tᵣᵢₛₖ, the road environment risk margin calculation unit 18 acquires a risk evaluation value Xᵢ. The road environment risk margin calculation unit 18 acquires the risk evaluation value Xᵢ corresponding to the road environment and the road environment condition based on the road environment recognized by the road environment recognition unit 17 and the road environment condition that belongs to the recognized road environment. For example, when n number of (n is a positive integer) road environments are included in the image captured at the risk calculation timing, the road environment risk margin calculation unit 18 may calculate the road environment risk margin M_{c} as shown in following Equation (1).

$${M}_{c} = {\sum }_{i = 1}^{n} {β}_{i} \times {X}_{i} \qquad ( 1 )$$

In Equation (1) above, specifically, the road environment risk margin calculation unit 18 acquires the risk evaluation value Xᵢ for each road environment included in the captured image (here, i is a positive integer equal to or greater than 1 and equal to or less than n). The road environment risk margin calculation unit 18 calculates the road environment risk margin M_{c} by calculating the sum of products of the risk evaluation value Xᵢ and coefficient βᵢ for the entire of i's. The coefficient βᵢ is a predetermined coefficient for making the road environment risk margin M_{c} be in a time dimension. The road environment risk margin M_{c} here is in the time dimension, but not limited thereto. The dimension of the road environment risk margin M_{c} may be dimensionless or may be another dimension as long as the dimension may be the same as that of a vehicle behavior risk margin M_{d} described later.

If it is determined by the explicit risk determination unit 16 that the explicit risk is present, the vehicle behavior risk margin calculation unit 19 calculates a vehicle behavior risk margin based on the result of recognition performed by the travel state recognition unit 13. The vehicle behavior risk margin is an index that represents a margin (a degree of allowance) of the risk affected by a behavior of the vehicle. As the behavior of the vehicle, the vehicle speed can be used as an example. For example, if it is determined by the explicit risk determination unit 16 that the explicit risk is present, the vehicle behavior risk margin calculation unit 19 calculates the vehicle behavior risk margin based on the vehicle speed history stored in the vehicle speed history storage unit 14. The vehicle behavior risk margin calculation unit 19 can calculate the vehicle behavior risk margin M_{d} using, for example, following Equation (2).

M_{d}=β₁×DARP=β₁×(w₁v₁+w₂v₂+w₃v₃) (2)

In Equation (2) above, specifically, the vehicle behavior risk margin calculation unit 19 acquires a maximum speed v₁, a median v₂ of the speed, and an average value v₃ of the changes of the speed from the vehicle speed history during a period (evaluation period) from when it is determined by the explicit risk determination unit 16 that the explicit risk is present to a certain previous time. The certain time for defining the evaluation period can be, for example, several seconds (for example, a constant of 4 seconds to 6 seconds). The vehicle behavior risk margin calculation unit 19 may perform weighting of the maximum speed v₁, the median v₂ of the speed, and the average value v₃ of the changes of the speed by multiplying the maximum speed v₁, the median v₂ of the speed, and the average value v₃ of the changes of the speed by coefficients w₁, w₂, and w₃, respectively. The coefficients w₁, w₂, and w₃ are coefficients for weighting the maximum speed v₁, the median v₂ of the speed, and the average value v₃ of the changes of the speed, respectively. The weighting here may be, for example, weighting for adjusting the influence degree of the maximum speed v₁, the median v₂ of the speed, and the average value v₃ of the changes of the speed on the vehicle behavior risk margin M_{d}, or may be weighting for performing a predetermined normalization for the maximum speed v₁, the median v₂ of the speed, and the average value v₃ of the changes of the speed. The coefficients w₁, w₂, and w₃ may be set experimentally (or empirically) by performing statistical processing on each of the maximum speed v₁, the median v₂ of the speed, and the average value v₃ of the changes of the speed and by performing, for example, a trial using a simulation or the like, based on, for example, the near-miss incident database described above. The vehicle behavior risk margin calculation unit 19 does not necessarily need to perform the weighting. Incidentally, on the right side of Equation (2) above, a value (a value in a parentheses) obtained by multiplying the maximum speed v₁, the median v₂ of the speed, and the average value v₃ of the changes of the speed by the coefficients w₁, w₂, and w₃, respectively corresponds to a driver accepted risk potential (DARP).

The vehicle behavior risk margin calculation unit 19 calculates the vehicle behavior risk margin M_{d} by multiplying the value obtained by multiplying the maximum speed v₁, the median v₂ of the speed, and the average value v₃ of the changes of the speed by the coefficients w₁, w₂, and w₃ respectively, by a coefficient β₁. The coefficient β₁ is a predetermined coefficient for making the vehicle behavior risk margin M_{d} be in the time dimension. The vehicle behavior risk margin M_{d} here is in the time dimension, but not limited thereto. The dimension of the vehicle behavior risk margin M_{d} may be dimensionless or may be another dimension as long as the dimension may be the same as that of the road environment risk margin M_{c} described above.

The driving assistance switching unit 20 switches whether or not to perform the driving assistance relating to the latent risk based on the road environment risk margin M_{c} and the vehicle behavior risk margin M_{d}.

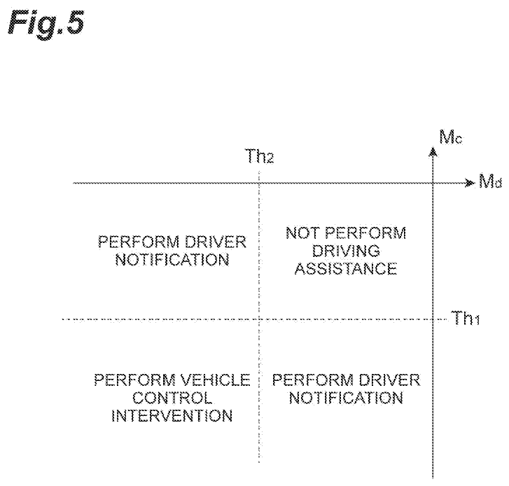

FIG. 5 is a diagram illustrating an example of switching the driving assistance relating to the latent risk. As illustrated in FIG. 5, for example, if the road environment risk margin M_{c} is equal to or greater than a first threshold value Th₁ and the vehicle behavior risk margin M_{d} is equal to or greater than a second threshold value Th₂, the driving assistance switching unit 20 performs switching such that the driving assistance relating to the latent risk is not performed.

If the road environment risk margin M_{c} is less than the first threshold value Th₁, or the vehicle behavior risk margin M_{d} is less than the second threshold value Th₂, the driving assistance switching unit 20 performs switching such that the driving assistance relating to the latent risk is performed. More specifically, if the road environment risk margin M_{c} is less than the first threshold value Th₁, and the vehicle behavior risk margin M_{d} is less than the second threshold value Th₂, the driving assistance switching unit 20 may perform switching such that the vehicle control intervention described later is performed as the driving assistance relating to the latent risk. If the road environment risk margin M_{c} is less than the first threshold value Th₁, and the vehicle behavior risk margin M_{d} is equal to or greater than the second threshold value Th₂, or if the road environment risk margin M_{c} is equal to or greater than the first threshold value Th₁, and the vehicle behavior risk margin M_{d} is less than the second threshold value Th₂, the driving assistance switching unit 20 may perform switching such that the driver notification described later is performed as the driving assistance relating to the latent risk.

The intervention performing unit 21 performs the vehicle control intervention for the avoidance of the latent risk based on the result of switching performed by the driving assistance switching unit 20, as the driving assistance relating to the latent risk. The intervention performing unit 21 performs, for example, at least one of a deceleration intervention and a steering intervention as the vehicle control intervention to the vehicle.

The intervention performing unit 21 here includes a deceleration intervention performing unit 21a that performs the deceleration intervention as the vehicle control intervention to the vehicle. For example, if the driving assistance switching unit 20 performs switching such that the deceleration intervention is performed, the deceleration intervention performing unit 21a calculates an upper limit vehicle speed of the vehicle for the deceleration intervention based on the road environment risk margin M_{c}. The upper limit vehicle speed means an upper limit value of the vehicle speed according to the possibility of the presence of the latent risk accompanying the explicit risk in front of the vehicle. The deceleration intervention performing unit 21a decelerates the vehicle not to exceed the calculated upper limit vehicle speed of the vehicle. For example, if the driving assistance switching unit 20 performs switching such that the deceleration intervention is performed, the deceleration intervention performing unit 21a may set, for example, a deceleration intervention permission flag to be ON to permit to perform the deceleration intervention such that the vehicle speed does not exceed the upper limit vehicle speed of the vehicle. The deceleration intervention permission flag is a control flag indicating whether or not to permit to perform the operation of the brake actuator by the deceleration intervention. Here, setting ON of the deceleration intervention permission flag corresponds to permit to perform the deceleration intervention, and setting OFF of the deceleration intervention permission flag corresponds not to permit to perform the deceleration intervention. The deceleration speed at the time of performing the deceleration intervention may be a deceleration speed set in advance or a deceleration speed set by a known method.

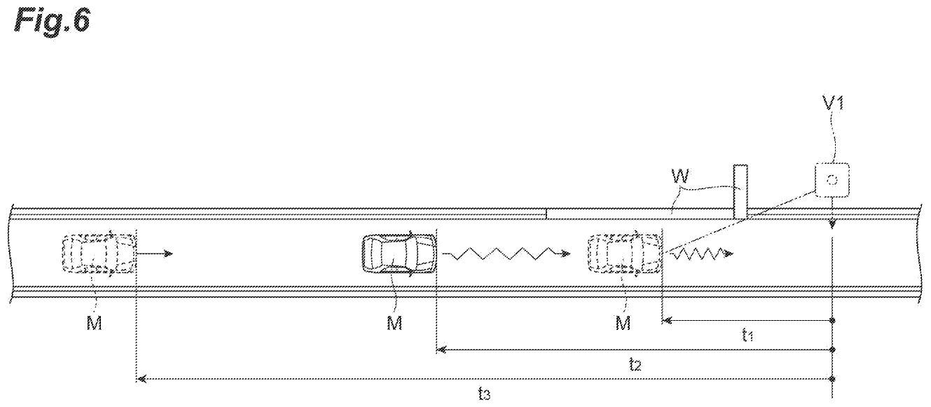

FIG. 6 is a plan view schematically illustrating an example of performing the deceleration intervention. FIG. 6 schematically illustrates a state of switching to perform the driving assistance relating to the latent risk and the deceleration intervention to the vehicle M in the situation illustrated in FIG. 2.

In FIG. 6, for example, it is determined by the explicit risk determination unit 16 that the explicit risk is present during a time from a time point t₃ to a time point t₂. At this time, the expected arrival time relating to the explicit risk is calculated. Since the time point t₂ is set to the risk calculation timing because, for example, the calculated expected arrival time is equal to or shorter than the predetermined determination time Tᵣᵢₛₖ. At the risk calculation timing, the driving assistance switching unit 20 performs switching such that the deceleration intervention is performed. In FIG. 6, the vehicle M at the time point t₂ (risk calculation timing) is illustrated by a solid line.

At the risk calculation timing, the road environment risk margin M_{c} is calculated by the road environment risk margin calculation unit 18 using the table in FIG. 4, and the vehicle behavior risk margin M_{d} is calculated by the vehicle behavior risk margin calculation unit 19 based on the vehicle speed history from the time point t₃ to the time point t₂. In the example in FIG. 6, the deceleration intervention performing unit 21a is permitted to perform the deceleration intervention based on the road environment risk margin M and the vehicle behavior risk margin M_{d} calculated at the risk calculation timing. The upper limit vehicle speed of the vehicle for the deceleration intervention can be calculated by introducing a safety cushion time SCT as follows. The safety cushion time (SCT) is a cushion time until the vehicle reaches the position of the actualized latent risk, assuming that the latent risk accompanying the explicit risk in front of the vehicle is supposed to be actualized. The safety cushion time SCT can be said to be an integrated risk margin. The integrated risk margin is an index obtained by integrating the road environment risk margin M_{c} and the vehicle behavior risk margin M_{d}, and is an index expressing the influence of the road environment and the vehicle behavior to the margin for the latent risk, using a common scale. The common scale means a physical index, and here, it is the “time” as an example.

In the example in FIG. 6, assuming that a virtual pedestrian V1 is supposed to cross in front of the vehicle M, the safety cushion time SCT can be a margin time until the vehicle M reaches the position of the virtual pedestrian V1 that has jumped out can be the safety cushion time SCT. The safety cushion time SCT can be calculated using the road environment risk margin Me and the vehicle behavior risk margin M_{d}, for example, as in the following Equations (3) to (6).

SCT=T_{b}+T_{d}+T_{c} (3)

T_{b}=β₀ (4)

T_{d}=M_{d} (5)

T_{c}=M_{c} (6)

Here, β₀ is a standard safety cushion time, and can be a constant set in advance. β₀ may be set in advance according to, for example, the road component condition and the external environmental element condition.

As expressed in Equations (5) and (6) described above, here, the dimensions of T_{c} (the road environment risk margin M_{c}), T_{d} (the vehicle behavior risk margin M_{d}), and the safety cushion time SCT are dimensions of “time” commonly. If the dimension of vehicle behavior risk margin M_{d} is a dimension other than the “time”, the vehicle behavior risk margin M_{d} on the right side of above Equation (5) may be multiplied by a coefficient that converts the dimension into the “time”, for example. In addition. If the dimension of the road environment risk margin M_{c} is a dimension other than the “time”, the road environment risk margin M_{c} on the right side of above Equation (6) may be multiplied by a coefficient that converts the dimension into the “time”, for example.

Based on above Equations (3) to (6), an upper limit vehicle speed V_{ref} of the vehicle for the deceleration intervention can be calculated, for example, as the following Equations (7) to (11). First, when above Equation (5) and above Equation (2) are substituted into above Equation (3), following Equation (7) is obtained.

SCT=T_{b}+T_{d}+T_{c}=T_{b}+(β₁×DARP)+T_{c} (7)

Here, a relationship between the vehicle speed V_{c} and the vehicle behavior risk margin M_{d} at the time point t₁ in FIG. 6 can be expressed by following Equation (8) by a linear approximation. However, “a” is a coefficient set in advance according to the correlation coefficient of the driver acceptance risk potential DARP.

V_{c}=a×DARP (8)

When above Equation (8) into above Equation (7), following Equation (9) is obtained.

$$SCT = {T}_{b} + ( {β}_{1} \times \frac{{V}_{c}}{a} ) + {T}_{c} \qquad ( 9 )$$

When above Equation (9) is rearranged for V_{c}, following Equation (10) is obtained.

$${V}_{c} = \frac{a}{{β}_{1}} \{ SCT - ( {T}_{b} + {T}_{c} ) \} \qquad ( 10 )$$

In above Equation (10), a, β₁, T_{b}, and T_{c} are known. Therefore, the value of V_{c} can be determined by determining the value of the safety cushion time SCT. For example, when a target value SCT* of the safety cushion time SCT at the timing (corresponding to t₁ in FIG. 6) at which the virtual pedestrian V1 is expected to be actualized, the value of V_{c} can be obtained as the upper limit vehicle speed V_{ref} as expressed in following Equation (10). The timing at which the virtual pedestrian V1 is expected to be actualized may be timing at which, for example, the vehicle M approaches the position of predetermined distance from the corner portion of the wall W, or may be timing at which the vehicle M approaches a position where the vehicle M faces the virtual position of the virtual pedestrian V1 via the corner portion of the wall W if the virtual position of the virtual pedestrian V1 is set in advance.

$${V}_{ref} = \frac{a}{{β}_{1}} \{ SCT * - ( {T}_{b} + {T}_{c} ) \} \qquad ( 11 )$$

In the example in FIG. 6, using the vehicle upper limit vehicle speed V_{ref} calculated as described above, the deceleration intervention performing unit 21a decelerates the vehicle M such that the speed of the vehicle M at time point t₁ does not exceed the upper limit vehicle speed V_{ref}. In this way, for example, it is possible to perform the deceleration intervention from a time point before the latent risk is actualized. Alternatively, for example, even if the latent risk is not actually present, it is possible to perform the deceleration intervention in consideration of the possibility of the presence of the latent risk. Therefore, it is possible to realize the driving assistance relating to the latent risk corresponding to a so-called “defensive driving”.

In addition, the intervention performing unit 21 here further includes a steering intervention performing unit 21b that performs the steering intervention as the vehicle control intervention to the vehicle. For example, if the steering intervention is performed by the driving assistance switching unit 20, the steering intervention performing unit 21b may set, for example, a steering intervention permission flag to be ON to permit the steering intervention. The steering intervention permission flag is a control flag indicating whether or not to permit to perform the operation of the steering actuator by the steering intervention. Here, setting ON of the steering intervention permission flag corresponds to permit to perform the steering intervention, and setting OFF of the steering intervention permission flag corresponds not to permit to perform the steering intervention. The steering angle speed at the time of performing the steering intervention may be a steering angle speed set in advance.

For example, if the driving assistance switching unit 20 performs switching such that the steering intervention is performed, the steering intervention performing unit 21b generates a risk potential based on the external environment of the vehicle M, the travel state of the vehicle M, the road environment risk margin M_{c} and the vehicle behavior risk margin M_{d}. The steering intervention performing unit 21b generates the risk potential using the upper limit vehicle speed V_{ref} calculated in the same manner as described above. As a result, the explicit risk and the latent risk accompanying the explicit risk and is likely to be present are included in the risk potential.

The steering intervention performing unit 21b calculates the target yaw rate based on the risk potential to avoid both the explicit risk and the latent risk likely to be present accompanying the explicit risk. The steering intervention performing unit 21b calculates the target steering angle from the target yaw rate. The steering intervention performing unit 21b calculates an assistance torque to be given to the steering section 8 to realize the target steering angle based on the target steering angle and the actual steering angle. The steering intervention performing unit 21b performs the steering intervention by giving an assist torque to the steering section 8 of the vehicle M by transmitting the control signal to the steering actuator.

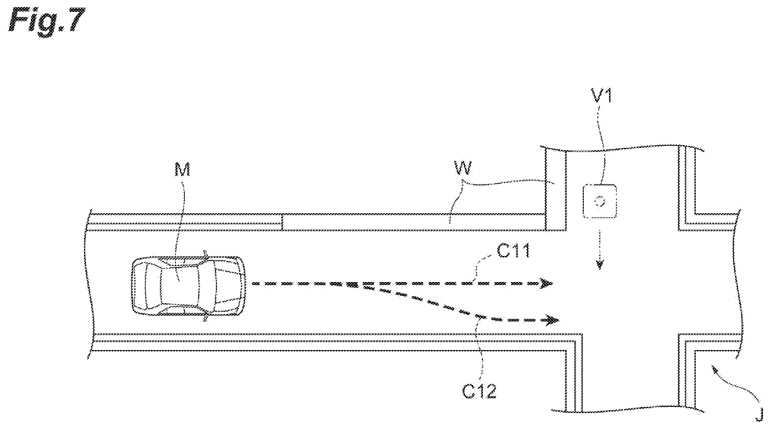

FIG. 7 is a plan view schematically illustrating an example of performing the steering intervention. FIG. 7 schematically illustrates a state of performing the steering intervention on the vehicle M in the situation illustrated in FIG. 2.

In FIG. 7, for example, the position of the vehicle M corresponds to the position at the risk calculation timing. At the risk calculation timing, the road environment risk margin M_{c} is calculated by the road environment risk margin calculation unit 18, and the vehicle behavior risk margin M_{d} is calculated by the vehicle behavior risk margin calculation unit 19. The risk potential is generated by the steering intervention performing unit 21b based on the road environment risk margin M_{c} and the vehicle behavior risk margin M_{d}. The target yaw rate and the target steering angle are calculated by the steering intervention performing unit 21b based on the risk potential. The steering intervention performing unit 21b gives the assistance torque based on the target yaw rate and the target steering angle. As a result thereof, the vehicle M is steered to travel along a trajectory C12 to avoid both the explicit risk and the latent risk likely to be present accompanying the explicit risk. A risk avoidance amount of the vehicle M (for example, an amount of the trajectory displacement between the trajectory C11 and the trajectory C12 in the lane width direction) may vary depending on the road environment risk margin M_{c} and the vehicle behavior risk margin M_{d}.

Incidentally, the intervention performing unit 21 may determine whether to perform any one of the deceleration intervention and the steering intervention, or to perform both the deceleration intervention and the steering intervention as the vehicle control intervention, based on the safety cushion time SCT described above and a vehicle control intervention selection threshold value set in advance. The vehicle control intervention selection threshold value is a threshold value of the safety cushion time SCT for selecting the content of the vehicle control intervention. The intervention performing unit 21 may determine whether or not to perform the steering intervention based on whether or not a steering intervention capable space is present around the vehicle based on the road situations and the object situations around the vehicle recognized by the external environment recognition unit 12 in addition to, for example, a comparison result between the safety cushion time SCT and the vehicle control intervention selection threshold value.

The driver notification performing unit 22 performs the driver notification based on the result of switching by the driving assistance switching unit 20. The driver notification is a notification to the driver of the vehicle of information relating to the latent risk as the driving assistance relating to the latent risk.

If the driving assistance switching unit 20 performs switching such that the driver notification is performed, the driver notification performing unit 22 displays an integrated risk margin that varies depending on the road environment risk margin M_{c} and the vehicle behavior risk margin M_{d} on the display 7a of the HMI 7. The integrated risk margin is an index having a meaning as a margin time that varies depending on the road environment risk margin M_{c} and the vehicle behavior risk margin M_{d}. For example, the safety cushion time SCT calculated as described above may be used as the integrated risk margin. The driver notification performing unit 22 may calculate the safety cushion time SCT based on the road environment risk margin M_{c} and the vehicle behavior risk margin M_{d} in the same manner as described above. In addition, the integrated risk margin may be calculated by a calculation different from the above method as long as the integrated risk margin has a meaning of the margin time in which the road environment risk margin M_{c} and the vehicle behavior risk margin M_{d} are integrated. The integrated risk margin is not necessarily to be the calculation method including only the addition of the road environment risk margin M_{c} and the vehicle behavior risk margin M_{d}, and may a calculation method including the subtraction, multiplication, or division.

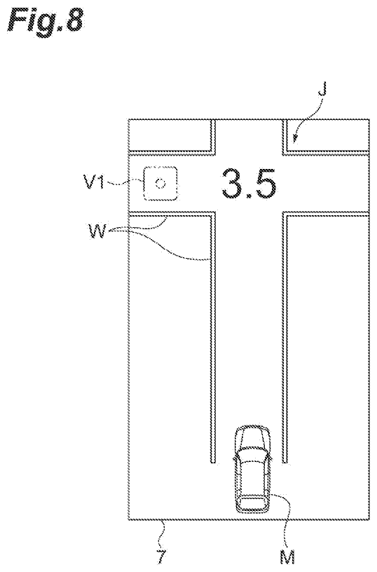

FIG. 8 is a diagram illustrating an example of displaying the integrated risk margin on the display unit. In FIG. 8, for example, a schematic image corresponding to the situation illustrated in FIG. 2 is displayed on the display 7a (for example, MID) of the HMI 7. In this image, the safety cushion time SCT (for example, 3.5 seconds) is displayed as the integrated risk margin. In the example in FIG. 8, the safety cushion time SCT is displayed at the position of an intersection J, but may be displayed at any position within the display area of the MID.

If the driving assistance switching unit 20 performs switching such that the driver notification is performed, the driver notification performing unit 22 may display an attention alert image on the display 7a of the HMI 7. The attention alert image is an image for alerting the driver about the risk in front of the vehicle. Attention alert image information relating to the attention alert image may be stored in advance in the ROM or the like of the ECU 10 in association with the road environment, for example.

The driver notification performing unit 22 acquires, for example, the road environment recognized by the road environment recognition unit 17. The driver notification performing unit 22 acquires the attention alert image corresponding to the acquired road environment based on, for example, the attention alert image information stored in advance in association with the road environment. The driver notification performing unit 22 determines a blinking mode of the attention alert image according to, for example, the vehicle behavior risk margin M_{d}.

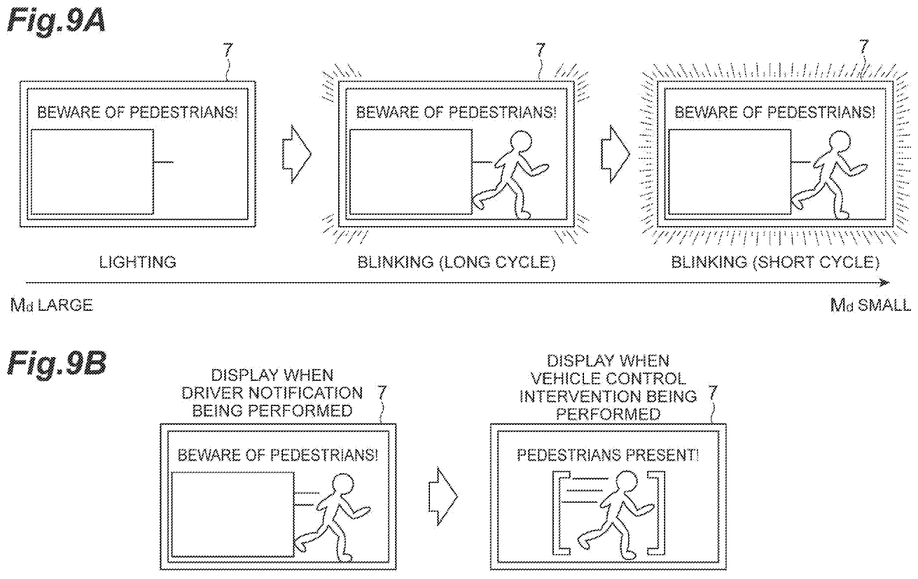

As the attention alert image, for example, the images illustrated in FIG. 9A and FIG. 9B can be used. FIG. 9A is a diagram illustrating an example of changes of the image display modes. As an example, FIG. 9A is an image illustrating that a pedestrian is likely to be present as a latent risk accompanying wall when the driving assistance switching unit 20 performs switching such that the driver notification is performed.

If the vehicle behavior risk margin M_{d} is less than a first image display threshold value (an image display threshold value), the driver notification performing unit 22 determines the blinking mode so that the attention alert image blinks in a short cycle compared to the case where the vehicle behavior risk margin M_{d} is equal to or greater than the first image display threshold value. Specifically, as illustrated in the center of FIG. 9A, the driver notification performing unit 22 may display a first image indicating a pedestrian crossing out of the wall on the display 7a of the HMI 7 in the mode of blinking at a predetermined first cycle (long cycle). The first image may include a text display stating “BEWARE OF PEDESTRIANS!”. For example, if the vehicle behavior risk margin M_{d} is less than a second image display threshold value, the driver notification performing unit 22 acquires the first image. For example, if the vehicle behavior risk margin M_{d} is equal to or greater than the first image display threshold value and less than the second image display threshold value, the driver notification performing unit 22 determines the blinking mode of the attention alert image to blink in the first cycle (long cycle).

As illustrated on the right side of FIG. 9A, for example, if the vehicle behavior risk margin M_{d} is less than the predetermined first image display threshold value, the driver notification performing unit 22 may display the first image indicating a pedestrian crossing out of the wall on the display 7a of the HMI 7 in mode of blinking in a second cycle (a short cycle) which is shorter than the first cycle. For example, if the vehicle behavior risk margin M_{d} is less than the second image display threshold value, the driver notification performing unit 22 may acquire the first image. If the vehicle behavior risk margin M_{d} is less than the first image display threshold value, the driver notification performing unit 22 determines the blinking mode of the attention alert image to blink in a second cycle (short cycle).

As illustrated on the left side of FIG. 9A, for example, if the vehicle behavior risk margin M_{d} is equal to or greater than a predetermined second image display threshold value, the driver notification performing unit 22 may display the second image indicating a state before the pedestrian crosses out of the wall on the display 7a of the HMI 7 in a lighting mode. The second image may include the text display stating “BEWARE OF PEDESTRIANS!”. For example, if the vehicle behavior risk margin M_{d} is equal to or greater than the second image display threshold value, the driver notification performing unit 22 acquires the second image. If the vehicle behavior risk margin M_{d} is equal to or greater than the second image display threshold value, the driver notification performing unit 22 determines the blinking mode of the attention alert image as the lighting mode.

The first image display threshold value is a threshold value of the vehicle behavior risk margin M_{d} for switching a blinking cycle (the display mode) of the first image. The second image display threshold value is a threshold value for switching the image between the first image and the second image and switching the display mode between the first image display mode and the second image display mode.

FIG. 9B is a diagram illustrating an example of displaying the image on the display unit. For example, in FIG. 9B, the images displayed on the display 7a of the HMI 7 are switched between the case where the driving assistance switching unit 20 performs switching such that the driver notification is performed and the case where the driving assistance switching unit 20 performs the switching such that the vehicle control intervention is performed. That is, the driver notification performing unit 22 may perform the driver notification when the driving assistance switching unit 20 performs switching such that the vehicle control intervention is performed. As illustrated on the right side of FIG. 9B, if the driving assistance switching unit 20 performs switching such that the vehicle control intervention is performed, the driver notification performing unit 22 may display a third image indicating a pedestrian and a symbol that emphasizes the pedestrian on the display 7a of the HMI 7. The third image is an image indicating that the pedestrian is a target of risk avoidance by the vehicle control intervention. The third image may include a text display stating “PEDESTRIANS PRESENT!”. For example, when the driving assistance switching unit 20 performs switching such that the vehicle control intervention is performed, the driver notification performing unit 22 may acquire the third image illustrated on the right side of FIG. 9B as the attention alert image instead of the first image illustrated in FIG. 9A. Example of Calculation Processing by ECU 10

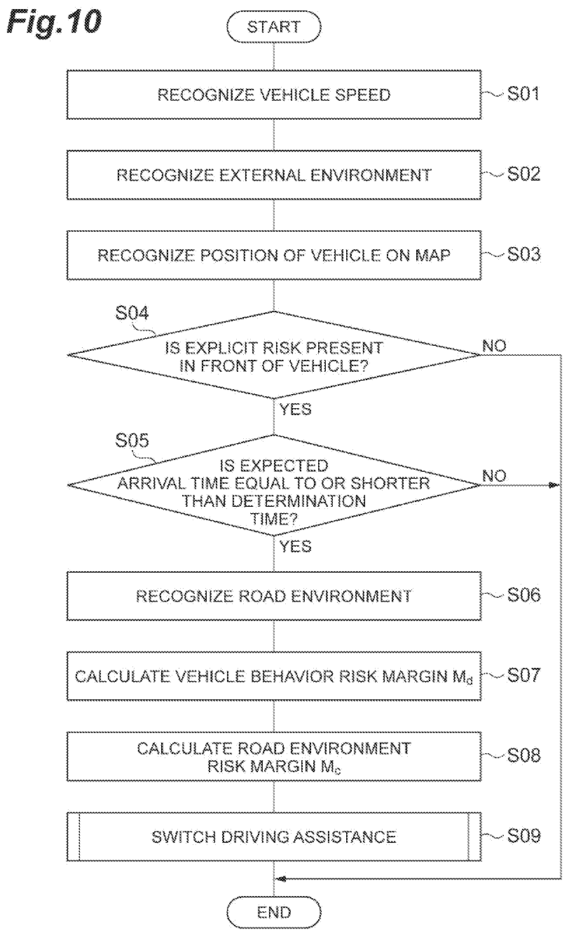

Next, an example of calculation processing by the ECU 10 will be described. FIG. 10 is a flowchart illustrating an outline of the driving assistance switching processing. The processing in the flowchart in FIG. 10 is executed, for example, during the traveling of the vehicle.

As illustrated in FIG. 10, in STEP S01, the ECU 10 recognizes the vehicle speed using the travel state recognition unit 13. The travel state recognition unit 13 recognizes the vehicle speed of the vehicle based on the result of measurement performed by the internal sensor 3. In addition, in STEP S01, the ECU 10 stores the vehicle speed using the vehicle speed history storage unit 14. The vehicle speed history storage unit 14 stores the vehicle speed history during the traveling of the vehicle based on the result of recognition of the vehicle speed performed by the travel state recognition unit 13.

In STEP S02, the ECU 10 recognizes the external environment using the external environment recognition unit 12. The external environment recognition unit 12 recognizes the external environmental elements as the external environment based on the result of detection performed by the external sensor 2.

In STEP S03, the ECU 10 recognizes the position of the vehicle on the map using the vehicle position recognition unit 11. The vehicle position recognition unit 11 recognizes a position of the vehicle on the map based on information on the position from the GPS receiver 1 and the map information in the map database 5.

In STEP S04, the ECU 10 determines whether or not the explicit risk is present in front of the vehicle using the explicit risk determination unit 16. If at least one explicit risk is recognized in the captured image, the explicit risk determination unit 16 determines that the explicit risk is present in front of the vehicle based on, for example, the result of detection performed by the external sensor 2 (the image captured by the camera). If the explicit risk is not recognized in the captured image, the explicit risk determination unit 16 determines that the explicit risk is not present in front of the vehicle.

If it is determined by the explicit risk determination unit 16 that the explicit risk is present in front of the vehicle (YES in S04), the ECU 10 calculates, in STEP S05, the expected arrival time relating to the recognized explicit risk using the explicit risk determination unit 16 and determines whether or not the expected arrival time is equal to or shorter than the determination time Tᵣᵢₛₖ.

If it is determined by the explicit risk determination unit 16 that the expected arrival time is equal to or shorter than the determination time Tᵣᵢₛₖ (YES in S05), the ECU 10 recognizes, in STEP S06, the road environment using the road environment recognition unit 17. The road environment recognition unit 17 recognizes the road environment in front of the vehicle based on the position of the vehicle on the map, the map information, and the external environment.

In STEP S07, the ECU 10 calculates the vehicle behavior risk margin M_{d} using the vehicle behavior risk margin calculation unit 19. The vehicle behavior risk margin calculation unit 19 calculates vehicle behavior risk margin M based on, for example, the vehicle speed history stored in the vehicle speed history storage unit 14.

In STEP S08, the ECU 10 calculates the road environment risk margin M_{c} using the road environment risk margin calculation unit 18. The road environment risk margin calculation unit 18 calculates the road environment risk margin M_{c} using, for example, the table in FIG. 4 in which the risk evaluation value and the road environment are associated with each other in advance.

In STEP S09, the ECU 10 switches the driving assistance relating to the latent risk using the driving assistance switching unit 20. The driving assistance switching unit 20 switches whether to or not to perform the driving assistance relating to the latent risk based on the road environment risk margin M_{c} and the vehicle behavior risk margin M_{d} (details will be described later). Thereafter, the ECU 10 ends the current processing in FIG. 10. For example, when the vehicle passes the position of the recognized explicit risk, the ECU 10 executes the processing of FIG. 10 again.

On the other hand, if it is determined by the explicit risk determination unit 16 that the explicit risk is not present in front of the vehicle (NO in S04), the ECU 10 ends the processing illustrated in FIG. 10. Alternatively, if it is determined by the explicit risk determination unit 16 that the explicit risk is present in front of the vehicle (YES in S04), and if it is determined by the explicit risk determination unit 16 that the expected arrival time is not equal to or shorter than the determination time Tᵣᵢₛₖ (NO in S05), the ECU 10 ends the processing illustrated in FIG. 10.

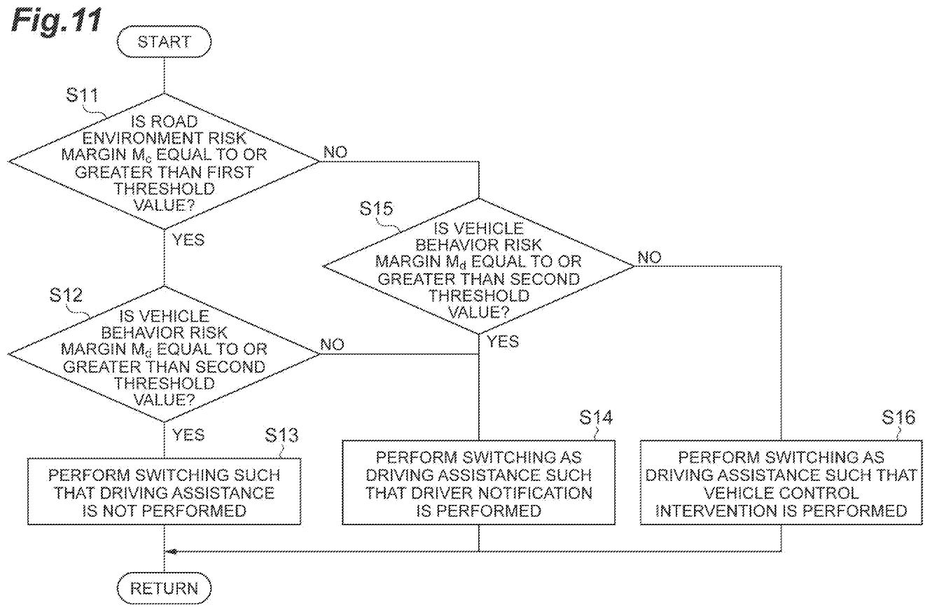

FIG. 11 is a flowchart illustrating details of the driving assistance switching processing. The processing in the flowchart in FIG. 11 is executed by the driving assistance switching unit 20 in STEP S09 in FIG. 10.

As illustrated in FIG. 11, in STEP S11, the ECU 10 determines whether or not the road environment risk margin M_{c} is equal to or greater than the first threshold value Th₁ using the driving assistance switching unit 20. If it is determined by the driving assistance switching unit 20 that the road environment risk margin M_{c} is equal to or greater than the first threshold value Th₁ (YES in S11), the ECU 10 determines, in STEP S12, whether or not the vehicle behavior risk margin M_{d} is equal to or greater than the second threshold value Th₂ using the driving assistance switching unit 20.

If it is determined by the driving assistance switching unit 20 that the vehicle behavior risk margin M_{d} is equal to or greater than the second threshold value Th₂ (YES in S12), the ECU 10 performs switching, in STEP S13, such that the driving assistance relating to the latent risk is not performed by the driving assistance switching unit 20. Thereafter, the ECU 10 ends the current processing in FIG. 11.

On the other hand, if it is determined by the driving assistance switching unit 20 that the vehicle behavior risk margin M_{d} is not equal to or greater than the second threshold value Th₂ (NO in S12), the ECU 10 performs switching, in STEP S14, such that the driver notification relating to the latent risk is performed as the driving assistance using the driving assistance switching unit 20. Thereafter, the ECU 10 ends the current processing in FIG. 11.

On the other hand, if it is determined by the driving assistance switching unit 20 that the road environment risk margin M_{c} is not equal to or greater than the first threshold value Th₁ (NO in S11), the ECU 10 determines, in STEP S15, whether or not the vehicle behavior risk margin M_{d} is equal to or greater than the second threshold value Th₂ using the driving assistance switching unit 20.

If it is determined by the driving assistance switching unit 20 that the vehicle behavior risk margin M_{d} is equal to or greater than the second threshold value Th₂ (YES in S15), the ECU 10 performs switching, in STEP S14, such that the driver notification relating to the latent risk is performed as the driving assistance using the driving assistance switching unit 20. Thereafter, the ECU 10 ends the current processing in FIG. 11.

On the other hand, if it is determined by the driving assistance switching unit 20 that the vehicle behavior risk margin M_{d} is not equal to or greater than the second threshold value Th₂ (NO in S15), the ECU 10 performs switching, in STEP S16, such that the vehicle control intervention relating to the latent risk is performed as the driving assistance using the driving assistance switching unit 20. Thereafter, the ECU 10 ends the current processing in FIG. 11.

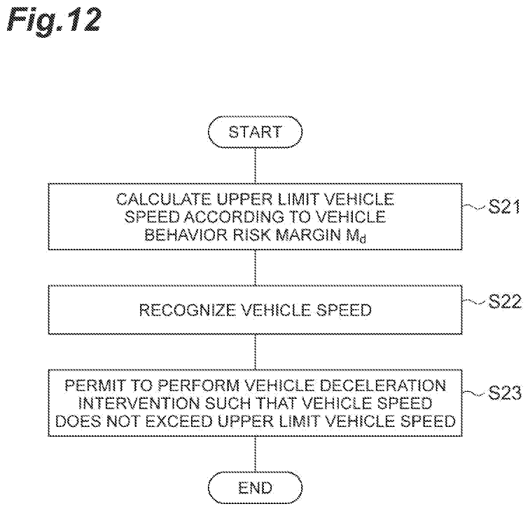

FIG. 12 is a flowchart illustrating deceleration intervention processing. The processing in the flowchart in FIG. 12 is executed by the deceleration intervention performing unit 21a when the deceleration intervention is selected to be performed as the vehicle control intervention by the intervention performing unit 21 in STEP S16 in FIG. 11.

As illustrated in FIG. 12, in STEP S21, the ECU 10 calculates the upper limit vehicle speed according to the vehicle behavior risk margin M_{d} using the deceleration intervention performing unit 21a. The deceleration intervention performing unit 21a calculates the upper limit vehicle speed of the vehicle for the deceleration intervention based on, for example, the road environment risk margin M_{c}.

In STEP S22, the ECU 10 recognizes the current vehicle speed of the vehicle using the travel state recognition unit 13. The travel state recognition unit 13 recognizes the vehicle speed of the vehicle based on the result of measurement performed by the internal sensor 3.

In STEP S23, the ECU 10 permits to perform the vehicle deceleration intervention such that the vehicle speed does not exceed the upper limit vehicle speed using the deceleration intervention performing unit 21a. The deceleration intervention performing unit 21a decelerates the vehicle not to exceed the calculated upper limit vehicle speed of the vehicle. For example, the deceleration intervention performing unit 21a sets the deceleration intervention permission flag to be ON to permit to perform the deceleration intervention such that the vehicle speed does not exceed the upper limit vehicle speed of the vehicle. Thereafter, the ECU 10 ends the processing of FIG. 12.

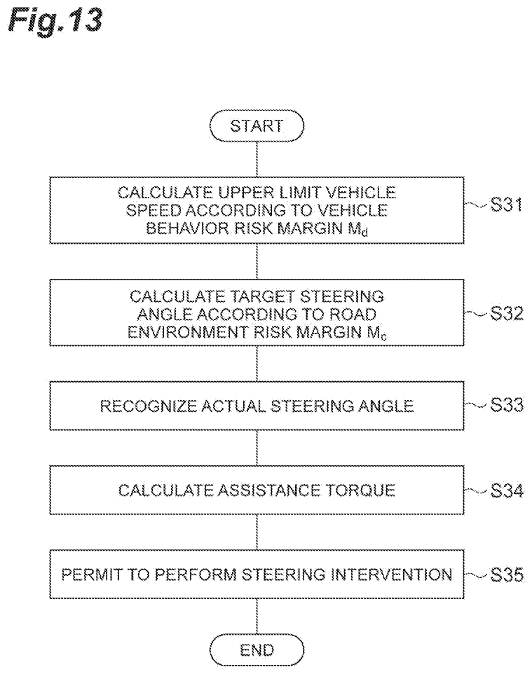

FIG. 13 is a flowchart illustrating steering intervention processing. The processing in the flowchart in FIG. 13 is executed by the steering intervention performing unit 21b when the steering intervention is selected to be performed as the vehicle control intervention by the intervention performing unit 21 in STEP S16 in FIG. 11.

As illustrated in FIG. 13, in STEP S31, the ECU 10 calculates the upper limit vehicle speed according to the vehicle behavior risk margin M_{d} using the steering intervention performing unit 21b. For example, the steering intervention performing unit 21b calculates the upper limit vehicle speed of the vehicle used for performing the steering intervention based on the road environment risk margin M_{c}.

In STEP S32, the ECU 10 calculates the target steering angle according to the road environment risk margin M_{c} using the steering intervention performing unit 21b. For example, the steering intervention performing unit 21b generates the risk potential using the calculated upper limit speed. The steering intervention performing unit 21b calculates the target yaw rate based on the risk potential to avoid both the explicit risk and the latent risk likely to be present accompanying the explicit risk. The steering intervention performing unit 21b calculates the target steering angle from the target yaw rate.

In STEP S33, the ECU 10 recognizes the actual steering angle using the travel state recognition unit 13. The travel state recognition unit 13 recognizes the actual steering angle of the vehicle based on the result of detection performed by the steering sensor that configures the driving operation detection unit 4.

In STEP S34, the ECU 10 calculates the assistance torque using the steering intervention performing unit 21b. The steering intervention performing unit 21b calculates an assistance torque to be given to the steering section 8 to realize the target steering angle based on the target steering angle and the actual steering angle.

In STEP S35, the ECU 10 permits to perform the steering intervention using the steering intervention performing unit 21b. For example, the steering intervention performing unit 21b sets the steering intervention permission flag to be ON to permit to perform the steering intervention to realize the target steering angle. Thereafter, the ECU 10 ends the processing of FIG. 13.

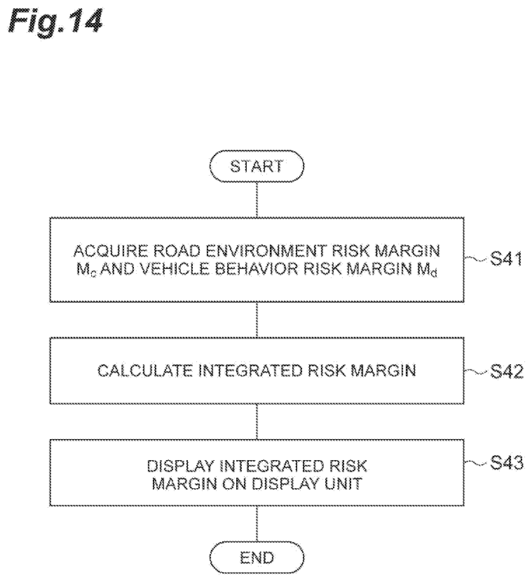

FIG. 14 is a flowchart illustrating an example of driver notification processing. The processing in the flowchart in FIG. 14 is executed by the driver notification performing unit 22 when, in STEP S14 of FIG. 11, the driving assistance switching unit 20 performs switching such that the driver notification is performed.

As illustrated in FIG. 14, in STEP S41, the ECU 10 acquires the road environment risk margin M_{c}, and the vehicle behavior risk margin M_{d} using the driver notification performing unit 22. For example, the driver notification performing unit 22 acquires the vehicle behavior risk margin M_{d} calculated by the vehicle behavior risk margin calculation unit 19 in STEP S07 in FIG. 10 and the road environment risk margin M_{c} calculated by the road environment risk margin calculation unit 18 in STEP S08 in FIG. 10.

In STEP S42, the ECU 10 calculates the integrated risk margin using the driver notification performing unit 22. The driver notification performing unit 22 calculates the safety cushion time SCT as the integrated risk margin based on, for example, the acquired road environment risk margin M_{c}, the vehicle behavior risk margin M_{d}, and T_{b}(β₀) described above.

In STEP S43, the ECU 10 displays the integrated risk margin on the display unit using the driver notification performing unit 22. For example, the driver notification performing unit 22 displays the image illustrated in FIG. 8 on the display 7a of the HMI 7. Thereafter, the ECU 10 ends the processing in FIG. 14.

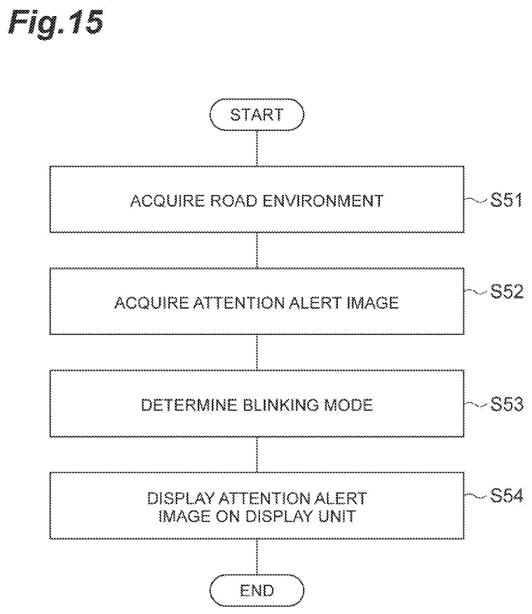

FIG. 15 is a flowchart illustrating another example of driver notification processing. The processing in the flowchart in FIG. 15 is executed by the driver notification performing unit 22 when the driving assistance switching unit 20 performs switching such that the driver notification is performed, in step S14 in FIG. 11. The processing in the flowchart in FIG. 15 may be executed when switching is performed such that the vehicle control intervention is performed, in STEP S16 in FIG. 11.

As illustrated in FIG. 15, in STEP S51, the ECU 10 acquires the road environment using the driver notification performing unit 22. For example, the driver notification performing unit 22 acquires the road environment recognized by the road environment recognition unit 17 in STEP S06 in FIG. 10.

In STEP S52, the ECU 10 acquires the attention alert image using the driver notification performing unit 22. For example, the driver notification performing unit 22 acquires the attention alert image corresponding to the acquired road environment based on the attention alert image stored in advance in association with the road environment. For example, if the vehicle behavior risk margin M_{d} is less than the second image display threshold value, the driver notification performing unit 22 acquires the first image displayed on the center and the right side of FIG. 9A. For example, if the vehicle behavior risk margin M_{d} is equal to or greater than the second image display threshold value, the driver notification performing unit 22 acquires the second image displayed on the left side of FIG. 9A. When switching is performed such that the vehicle control intervention is performed in STEP S16 of FIG. 11, the driver notification performing unit 22 may acquire the third image illustrated on the right side of FIG. 9B as the attention alert image instead of the first image illustrated in FIG. 9A.

In STEP S53, the ECU 10 determines the blinking mode of the attention alert image according to the vehicle behavior risk margin M_{d} using the driver notification performing unit 22. The driver notification performing unit 22 determines the blinking mode of the attention alert image according to, for example, the vehicle behavior risk margin M_{d}. For example, if the vehicle behavior risk margin M_{d} is equal to or greater than the first image display threshold value and less than the second image display threshold value, the driver notification performing unit 22 determines the blinking mode of the attention alert image in a mode of blinking at the first cycle (the long cycle) as illustrated on the center of FIG. 9A. For example, if the vehicle behavior risk margin M_{d} is less than the first image display threshold value, the driver notification performing unit 22 determines the blinking mode of the attention alert image in a mode of blinking at the second cycle (the short cycle) as illustrated on the right side of FIG. 9A. For example, if the vehicle behavior risk margin M_{d} is equal to or greater than the second image display threshold value, the driver notification performing unit 22 determines the blinking mode of the attention alert image in the lighting mode as illustrated on the left side of FIG. 9A.

In STEP S54, the ECU 10 displays the attention alert image on the display unit using the driver notification performing unit 22. For example, the driver notification performing unit 22 displays the attention alert image acquired in STEP S52 on the display 7a of the HMI 7 in the blinking mode determined in STEP S53. Thereafter, the ECU 10 ends the processing of FIG. 15.

### Operational Effects of Driving Assistance System 100

As described above, according to driving assistance system 100, the driving assistance switching unit 20 performs switching whether or not to perform the driving assistance relating to the latent risk based on the road environment risk margin M_{c} as well as the vehicle behavior risk margin M_{d} which is based on the result of recognition performed by the travel state recognition unit 13. Here, the road environment risk margin M_{c} is calculated from the road environment as the total value of the risk evaluation values using data in which the risk evaluation value Xᵢ representing the possibility of the presence of the latent risk accompanying the explicit risk and the road environment are associated with other in advance. Therefore, according to the driving assistance system 100, it is possible to perform switching whether or not perform the driving assistance relating to the latent risk while taking a fact that the possibility of the presence of the latent risk accompanying the explicit risk varies depending on the road environment into consideration. As a result thereof, for example, it is possible to perform the driving assistance relating to the latent risk while suppressing the driver from feeling the discomfort and taking the possibility of presence of the latent risk accompanying the explicit risk into consideration compared to a case where the driving assistance relating to the latent risk is performed on the vehicle under the assumption that the latent risk is always present.

In the driving assistance system 100, if the road environment risk margin M_{c} is equal to or greater than the first threshold value Th₁ and the vehicle behavior risk margin M_{d} is equal to or greater than the second threshold value Th₂, the driving assistance switching unit 20 performs switching such that the driving assistance relating to the latent risk is not performed. If the road environment risk margin M_{c} is less than the first threshold value Th₁, or the vehicle behavior risk margin M_{d} is less than the second threshold value Th₂, the driving assistance switching unit 20 performs switching such that the driving assistance relating to the latent risk is performed. In this way, if the road environment risk margin M_{c} is equal to or greater than the first threshold value Th₁ and the vehicle behavior risk margin M_{d} is equal to or greater than the second threshold value Th₂, since the driving assistance relating to the latent risk is not performed, it is possible to suppress the driver from feeling the discomfort.

The driving assistance system 100 includes the intervention performing unit 21 that performs the vehicle control intervention for the avoidance of the latent risk as the driving assistance relating to the latent risk based on the result of switching performed by the driving assistance switching unit 20. If the road environment risk margin M_{c} is less than the first threshold value Th₁ and the vehicle behavior risk margin M_{d} is less than the second threshold value Th₂, the driving assistance switching unit 20 performs switching such that the vehicle control intervention is performed. In this way, it is possible to suppress the driver from feeling the discomfort compared to a case where the vehicle control intervention is performed under the assumption that the latent risk is always present.

In the driving assistance system 100, when performing the deceleration intervention as the vehicle control intervention to the vehicle, the intervention performing unit 21 decelerates the vehicle such that the vehicle speed does not exceed the upper limit vehicle speed V_{ref} of the vehicle set according to the road environment risk margin M_{c}. In this way, it is possible to perform the deceleration intervention using the upper limit vehicle speed V_{ref} in which the possibility of the presence of the latent risk accompanying to explicit risk is taken into consideration.

The driving assistance system 100 includes the driver notification performing unit 22 that performs the driver notification which is a notification of the information relating to the latent risk to the driver of the vehicle as the driving assistance relating to the latent risk, based on the result of switching performed by the driving assistance switching unit 20. If the road environment risk margin M_{c} is less than the first threshold value Th₁ and the vehicle behavior risk margin M_{d} is equal to or greater than the second threshold value Th₂, or if the road environment risk margin M_{c} is equal to or greater than the first threshold value Th₁ and vehicle behavior risk margin is less than the second threshold value, the driving assistance switching unit 20 performs switching such that the driver notification is performed. In this way, it is possible to alert the driver while suppressing the driver from feeling the discomfort compared to a case where the driver notification is performed under the assumption that the latent risk is always present.

The driving assistance system 100 includes the display 7a of the HMI 7 that displays the information to the driver of the vehicle. The driver notification performing unit 22 displays, for example, the safety cushion time SCT on the display 7a of the HMI 7 as the integrated risk margin that varies depending on the road environment risk margin M_{c} and the vehicle behavior risk margin M_{d}. In this way, it is possible for the driver to recognize the degree of attention to be paid to the latent risk accompanying the explicit risk via the integrated risk margin that varies depending on the road environment risk margin M_{c} and the vehicle behavior risk margin M_{d}.

The driving assistance system 100 includes the display 7a of the HMI 7 that displays the information to the driver of the vehicle. The driver notification performing unit 22 acquires the road environment recognized by the road environment recognition unit 17, and acquires the attention alert image corresponding to the acquired road environment based on the attention alert image information stored in advance in association with the road environment. If the vehicle behavior risk margin M_{d} is less than the first image display threshold value, the driver notification performing unit 22 determines the blinking mode in which the attention alert image blinks at the shorter cycle compared to a case when the vehicle behavior risk margin M_{d} is equal to or greater than the first image display threshold value, and then, displays the attention alert image on the display 7a of HMI7 at the determined blinking mode. In this way, it is possible to alert the driver according to the vehicle behavior risk margin M_{d} according to the changes of the blinking cycle of the attention alert image.

### Modification Example

As above, an embodiment is described above, the present disclosure is not limited to the embodiment described above. The present disclosure can be embodied in various forms including various modifications and improvements based on the knowledge of those skilled in the art, including the above-described embodiment.

The risk evaluation value does not necessarily need to be an index representing the possibility of the presence of latent risk accompanying the explicit risk, but may be an index relating to latent risk accompanying the explicit risk. For example, the risk evaluation value may be an index that represents a jump-out risk of the latent risk accompanying the explicit risk. The risk evaluation value may be an index that represents a jump-out speed of the latent risk accompanying the explicit risk. In this case, for example, the jump-out speed corresponding to the types of the latent risk accompanying the explicit risk (for example, the pedestrian, the bicycle, another vehicle, and the like) may be stored in a table or the like in advance as data in which the risk evaluation value and the road environment are associated with each other in advance. Alternatively, an element as to whether or not a preceding vehicle performs rapid deceleration may be considered in the risk evaluation value. In this case, for example, the risk evaluation value relating to the latent risk accompanying the preceding vehicle (the explicit risk) may be adjusted according to a behavior of the preceding vehicle as the explicit risk (for example, a zig zag driving), or a state of the driver of the preceding vehicle (for example, looking aside) acquired by the vehicle-to-vehicle communication with the preceding vehicle.

If the road environment risk margin M_{c} is equal to or greater than the first threshold value Th₁ and the vehicle behavior risk margin M_{d} is equal to or greater than the second threshold value Th₂, the driving assistance switching unit 20 does not necessarily need to perform switching such that the driving assistance relating to the latent risk is not performed. If the road environment risk margin M_{c} is less than the first threshold value Th₁ or the vehicle behavior risk margin M_{d} is less than the second threshold value Th₂, the driving assistance switching unit 20 does not necessarily need to perform switching such that the driving assistance relating to the latent risk is performed. That is, the driving assistance switching unit 20 may perform switching whether or not to perform the driving assistance relating to the latent risk based on the road environment risk margin M_{c} and the vehicle behavior risk margin M_{d} without using both the first threshold value Th₁ and the second threshold value Th₂. The driving assistance switching unit 20 may perform switching the presence or absence of the driving assistance relating to the latent risk from the road environment risk margin M_{c} and the vehicle behavior risk margin M_{d} using, for example, the data in which a combination of the road environment risk margin M_{c} and the vehicle behavior risk margin M_{d} is associated with the presence of absence of the driving assistance in advance.

If the road environment risk margin M_{c} is less than the first threshold value Th₁ and the vehicle behavior risk margin M_{d} is less than the second threshold value Th₂, the driving assistance switching unit 20 does not necessarily need to perform switching such that the vehicle control intervention is performed. That is, the driving assistance switching unit 20 may perform switching whether or not to perform the vehicle control intervention based on the road environment risk margin M_{c} and the vehicle behavior risk margin M_{d} without using both the first threshold value Th₁ and the second threshold value Th₂. The driving assistance switching unit 20 may perform switching the presence or absence of the vehicle control intervention from the road environment risk margin M_{c} and the vehicle behavior risk margin M_{d} using, for example, the data in which a combination of the road environment risk margin M_{c} and the vehicle behavior risk margin M_{d} is associated with the presence of absence of the vehicle control intervention in advance.

If the road environment risk margin M_{c} is less than the first threshold value Th₁ and the vehicle behavior risk margin M_{d} is equal to or greater than the second threshold value Th₂, the driving assistance switching unit 20 does not necessarily need to perform switching such that the driver notification is performed. If the road environment risk margin M_{c} is equal to or greater than the first threshold value Th₁ and the vehicle behavior risk margin M_{d} is less than the second threshold value Th₂, the driving assistance switching unit 20 does not necessarily need to perform switching such that the driver notification is performed. That is, the driving assistance switching unit 20 may perform switching whether or not to perform driver notification based on the road environment risk margin M_{c} and the vehicle behavior risk margin M_{d} without using both the first threshold value Th₁ and the second threshold value Th₂. The driving assistance switching unit 20 may perform switching the presence or absence of the driver notification from the road environment risk margin M_{c} and the vehicle behavior risk margin M_{d} using, for example, the data in which a combination of the road environment risk margin M_{c} and the vehicle behavior risk margin M_{d} is associated with the presence or absence of the driver notification in advance.

The driving assistance switching unit 20 may perform switching whether or not to perform the driving assistance relating to the latent risk based on, for example, a result of comparison between a threshold value different from the first threshold value Th₁ and the second threshold value Th₂ and another indicator based on the road environment risk margin M_{c} and the vehicle behavior risk margin M_{d}.

In the embodiment described above, the example is described, in which both the deceleration intervention and the steering intervention are performed as the vehicle control intervention, but the present disclosure is not limited thereto. The deceleration intervention may not be performed. In this case, the deceleration intervention performing unit 21a may be omitted. Alternatively, the steering intervention may not be performed. In this case, the steering intervention performing unit 21b may be omitted. The vehicle control intervention may include a driving assistance relating to the latent risk other than the deceleration intervention and the steering intervention. The vehicle control intervention may not be performed as the driving assistance relating to the latent risk. In this case, the intervention performing unit 21 may be omitted.

Although the example of displaying the images on the HMI7 is described as the driver notification, but for example, the driver notification may be realized by outputting a sound, a voice, light, or the like to the driver, or by a vibration of a seat on which the driver is seated. In addition, although the example of performing the driver notification even when the driving assistance switching unit 20 performs switching such that the vehicle control intervention is performed, however, only the vehicle control intervention may be performed without the driver notification being performed. The driver notification may not be performed as the driving assistance relating to the latent risk. In this case, the driver notification performing unit 22 may be omitted.

What is claimed is:

1. A driving assistance system that can perform a driving assistance for a vehicle, comprising:
a vehicle speed recognition unit configured to recognize a vehicle speed of the vehicle;
a map database configured to store map information;
a vehicle position recognition unit configured to recognize a position of the vehicle on a map;
an external environment recognition unit configured to recognize an external environment of the vehicle;
a road environment recognition unit configured to recognize a road environment in front of the vehicle based on the position of the vehicle on the map, the map information, and the external environment;
an explicit risk determination unit configured to determine whether or not an explicit risk is present in front of the vehicle based on the external environment;
a vehicle behavior risk margin calculation unit configured to calculate a vehicle behavior risk margin based on a result of recognition performed by the vehicle speed recognition unit, if it is determined by the explicit risk determination unit that the explicit risk is present;
a road environment risk margin calculation unit configured to calculate a road environment risk margin from the road environment using data in which a risk evaluation value relating to a latent risk accompanying the explicit risk and the road environment are associated with each other in advance, if it is determined by the explicit risk determination unit that the explicit risk is present; and
a driving assistance switching unit configured to perform switching whether or not to perform the driving assistance relating to the latent risk based on the road environment risk margin and the vehicle behavior risk margin.

2. The driving assistance system according to claim 1,
wherein the driving assistance switching unit is configured to perform switching such that the driving assistance relating to the latent risk is not performed if the road environment risk margin is equal to or greater than a first threshold value and the vehicle behavior risk margin is equal to or greater than a second threshold value, and
the driving assistance switching unit is configured to perform switching such that the driving assistance relating to the latent risk is performed, if the road environment risk margin is less than the first threshold value or the vehicle behavior risk margin is less than the second threshold value.

3. The driving assistance system according to claim 2, further comprising:
an intervention performing unit configured to perform a vehicle control intervention for an avoidance of the latent risk as the driving assistance relating to the latent risk based on a result of switching performed by the driving assistance switching unit,
wherein the driving assistance switching unit is configured to perform switching such that the vehicle control intervention is performed, if the road environment risk margin is less than the first threshold value and the vehicle behavior risk margin is less than the second threshold value.

4. The driving assistance system according to claim 3,
wherein the intervention performing unit is configured to decelerate the vehicle such that the vehicle speed does not exceed an upper limit vehicle speed of the vehicle set according to the road environment risk margin, if a deceleration intervention is performed as the vehicle control intervention to the vehicle.

5. The driving assistance system according to claim 2, further comprising:
a driver notification performing unit configured to perform a driver notification that is a notification of information relating to the latent risk to a driver of the vehicle as the driving assistance relating to the latent risk, based on a result of switching performed by the driving assistance switching unit,
wherein the driving assistance switching unit is configured to perform switching such that the driver notification is performed, if the road environment risk margin is less than the first threshold value and the vehicle behavior risk margin is equal to or greater than the second threshold value, or if the road environment risk margin is equal to or greater than the first threshold value and the vehicle behavior risk margin is less than the second threshold value.

6. The driving assistance system according to claim 5, further comprising:
a display unit configured to display the information to the driver of the vehicle,
wherein the driver notification performing unit is configured to display an integrated risk margin that varies according to the road environment risk margin and the vehicle behavior risk margin on the display unit.

7. The driving assistance system according to claim 5, further comprising:
a display unit configured to display the information to the driver of the vehicle,
wherein the driver notification performing unit is configured to:
acquire a road environment recognized by the road environment recognition unit,
acquire an attention alert image corresponding to the acquired road environment, based on attention alert image information stored in advance in association with the road environment,
if the vehicle behavior risk margin is less than an image display threshold value, determine a blinking mode such that the attention alert image blinks at a shorter cycle compared to a case where the vehicle behavior risk margin is equal to or greater than the image display threshold value, and
display the attention alert image on the display unit in the determined blinking mode.

8. The driving assistance system according to claim 6, further comprising:
a display unit configured to display the information to the driver of the vehicle,
wherein the driver notification performing unit is configured to:
acquire a road environment recognized by the road environment recognition unit,
acquire an attention alert image corresponding to the acquired road environment, based on attention alert image information stored in advance in association with the road environment,
if the vehicle behavior risk margin is less than an image display threshold value, determine a blinking mode such that the attention alert image blinks at a shorter cycle compared to a case where the vehicle behavior risk margin is equal to or greater than the image display threshold value, and
display the attention alert image on the display unit in the determined blinking mode.
